(19) United States
(12) Patent Application Publication
(10) Pub. No.: US 2014/0136648 A1
(43) Pub. Date: May 15, 2014

(54) STORAGE APPARATUS, NETWORK INTERFACE APPARATUS, AND STORAGE CONTROL METHOD

(71) Applicants: Masateru Hemmi, Odawara (JP); Yuta Saito, Fujisawa (JP); Sophanna Tang, Odawara (JP); Shohei Shimahara, Odawara (JP)

(72) Inventors: Masateru Hemmi, Odawara (JP); Yuta Saito, Fujisawa (JP); Sophanna Tang, Odawara (JP); Shohei Shimahara, Odawara (JP)

(73) Assignee: HITACHI, LTD., Tokyo (JP)

(21) Appl. No.: 13/702,340

(22) PCT Filed: Nov. 13, 2012
(86) PCT No.: PCT/JP2012/007276

§ 371 Date: Dec. 6, 2012

(51) Int. Cl. H04L 12/24; H04L 29/08

(52) U.S. Cl. CPC H04L 41/0806; H04L 67/1097
USPC 709/216; 709/220

(57) ABSTRACT

A controller is able to specify one of multiple protocols, and to operate a network interface using the specified protocol. A storage apparatus comprises a network interface part, which is coupled to a computer via a network, and a controller, which is coupled to the network interface part, receives a request from the computer via the network and the network interface part, and accesses a storage medium on the basis of the request. The controller specifies one protocol from among multiple protocols, and sends protocol information denoting the specified protocol to the network interface part. The network interface part configures a protocol denoted by the protocol information, and carries out communications with the network in accordance with the configured protocol.

### TECHNICAL FIELD

The present invention relates to a storage apparatus.

### BACKGROUND ART

A storage apparatus front-end interface circuit board, which supports a single protocol, is known. When the protocol in use changes, the front-end interface circuit board must be replaced with one that supports the desired protocol.

Furthermore, protocols used in front-end interfaces are diversifying. To cope with this diversification, a method via which software, which supports multiple protocols, is incorporated into either the front-end interface or its processor, multiple protocols are accepted, and a received command is distributed to a driver that supports the protocol is known (For example, Patent Literature 1 and 2).

### CITATION LIST

### Patent Literature

### [PTL 1]

U.S. Pat. No. 8,108,882 (Specification)

### [PTL 2]

US Patent Application Publication No. 2005/0138154 (Specification)

### SUMMARY OF INVENTION

### Technical Problem

In a distribution method like that mentioned above, a storage apparatus controller is not able to configure a front-end interface protocol even when a front-end interface circuit board, which supports multiple protocols, is incorporated into the storage apparatus.

### Solution to Problem

Regarding a storage apparatus that is one aspect of the present invention, the storage apparatus comprises a network interface part, which is coupled to a computer via a network, and a controller, which is coupled to the network interface part, receives a request from the computer via the network and the network interface part, and accesses a storage medium based on the request. The controller specifies one protocol from among multiple protocols, and sends protocol information denoting the specified protocol to the network interface part. The network interface part configures a protocol denoted by the protocol information, and carries out communications with the network in accordance with the configured protocol.

### Advantageous Effects of Invention

According to one aspect of the present invention, a controller is able to specify one of multiple protocols, and to run a network interface using the specified protocol.

### BRIEF DESCRIPTION OF DRAWINGS

FIG. 1 shows the configuration of a storage system related to Example 1 of the present invention.

FIG. 2 shows the configuration of a storage apparatus 10 related to Example 1.

FIG. 3 shows the configuration of a channel coupling part 120a, which supports multiple protocols.

FIG. 4 shows the configuration of a SFP slot 123a.

FIG. 5 shows the configuration of a channel coupling part 120b, which supports only one protocol.

FIG. 6 shows information stored in a local memory 113.

FIG. 7 shows a circuit board protocol table 1110.

FIG. 8 shows a SFP type table 1120.

FIG. 9 shows a SFP bit rate table 1130.

FIG. 10 shows a device ID table 1140.

FIG. 11 shows a port mapping table 1200.

FIG. 12 schematically shows a protocol switching process.

FIG. 13 shows a protocol switching process.

FIG. 14 shows a port setting process.

FIG. 15 shows a setting information change process.

FIG. 16 shows the format of a physical address of a host communication control part 121a.

FIG. 17 shows a MAC-WWN translation process.

FIG. 18 shows a WWN-MAC translation process.

FIG. 19 shows a rewrite process.

FIG. 20 shows a in-use SFP determination process.

FIG. 21 shows a hardware pins determination process.

FIG. 22 shows a reception protocol determination process.

FIG. 23 shows a first screen transition in a protocol switching process.

FIG. 24 shows a second screen transition in the protocol switching process.

FIG. 25 shows a third screen transition in the protocol switching process.

FIG. 26 shows the configuration in the storage apparatus 10 for receiving a command.

FIG. 27 shows an Ethertype table 1310.

FIG. 28 shows a S_ID table 1320.

FIG. 29 shows an Initiator_ID table 1330.

FIG. 30 shows a MP search table 1340.

FIG. 31 shows a receive control process.

FIG. 32 shows a request receive process.

FIG. 33 shows the configuration in the storage apparatus 10 for sending a response.

FIG. 34 shows a response send process.

FIG. 35 shows a variation of the response send process.

FIG. 36 shows a send control process.

FIG. 37 shows the configuration of a storage apparatus 10p related to Example 2.

FIG. 38 shows the configuration of a channel coupling part 120c, which supports multiple protocols.

FIG. 39 shows the configuration of a channel coupling part 120d, which supports only one protocol.

FIG. 40 schematically shows a variation of the protocol switching process.

FIG. 41 shows the variation of the protocol switching process.

FIG. 42 shows a variation of the port setting process.

FIG. 43 schematically shows a variation of the selection process.

FIG. 44 shows the variation of the selection process.

### DESCRIPTION OF EMBODIMENTS

A number of examples will be explained. The technical scope of the present invention is not limited to the examples.

In the following explanation, the information of the present invention is explained using expressions such as “aaa table”, “aaa list”, “aaa DB”, and “aaa queue”, but this information may also be expressed using a data structure other than a table, a list, a DB, or a queue. Therefore, to show that this information is not dependent on the data structure, the “aaa table”, the “aaa list”, the “aaa DB”, and the “aaa queue” may be called “aaa information”.

When explaining the content of the respective information, the expressions “identification information”, “identifier”, “name” and “ID” are used, but these expressions are interchangeable.

In the following explanation, there may be cases where an explanation is given using a “program” as the doer of the action, but since the stipulated processing is performed in accordance with a program being executed by a processor while using a memory and a communication port (a communication control device), the explanation may also give the processor as the doer of the action. A process, which is disclosed as having the program as the doer of the action, may be regarded as a process performed by a management server or other such computer, or information processing apparatus. Furthermore, either all or a portion of a program may be realized in accordance with dedicated hardware.

Various types of programs may be installed in respective computers using a program delivery server or computer readable storage media.

A management terminal apparatus comprises an input/output device. Examples of the input/output device may include a display, a keyboard, and a pointer device, but the input/output device may be another device. As an alternative to the input/output device, a serial interface or a Ethernet interface may be used as an input/output device, a computer for display use comprising a display, a keyboard, or a pointer device may be coupled to the relevant interface, and by sending display information to the display computer and receiving input information from the display computer, the relevant interface may substitute for the input and display of an input/output device by carrying out a display on and receiving input from the display computer.

The storage apparatus comprises a controller for controlling the storage apparatus, and a front-end interface for coupling the host computer. The front-end interface supports multiple protocols. In the following explanation, a FC (Fibre Channel), a FCoE (Fibre Channel over Ethernet), and a iSCSI (Internet Small Computer System Interface) will be used as examples of protocols (Ethernet is a registered trademark).

It is supposed here that the controller configures a protocol in a volatile memory in the front-end interface, and that the controller performs a hard reset (hardware reset) for the front-end interface. The hard reset is a reset of the front-end interface hardware, and initializes the volatile memory in the front-end interface. Since the configured protocol information is lost in accordance with this, the front-end interface is not able to operate in accordance with the configured protocol.

In the following example, the controller specifies one protocol from among multiple protocols, and writes setting information denoting the specified protocol to a nonvolatile memory. After that, the controller performs a hard reset of the front-end interface. Thereafter, the front-end interface reads the setting information stored in the nonvolatile memory, and boots up on the basis of this setting information. This makes it possible for the controller to access the front-end interface, and enables the front-end interface to operate in accordance with the protocol specified by the controller.

### Example 1

In this example, a storage system comprising a large storage apparatus will be explained.

### —Configuration of Storage System of Example 1—

The configuration of a storage system of Example 1 will be explained hereinbelow.

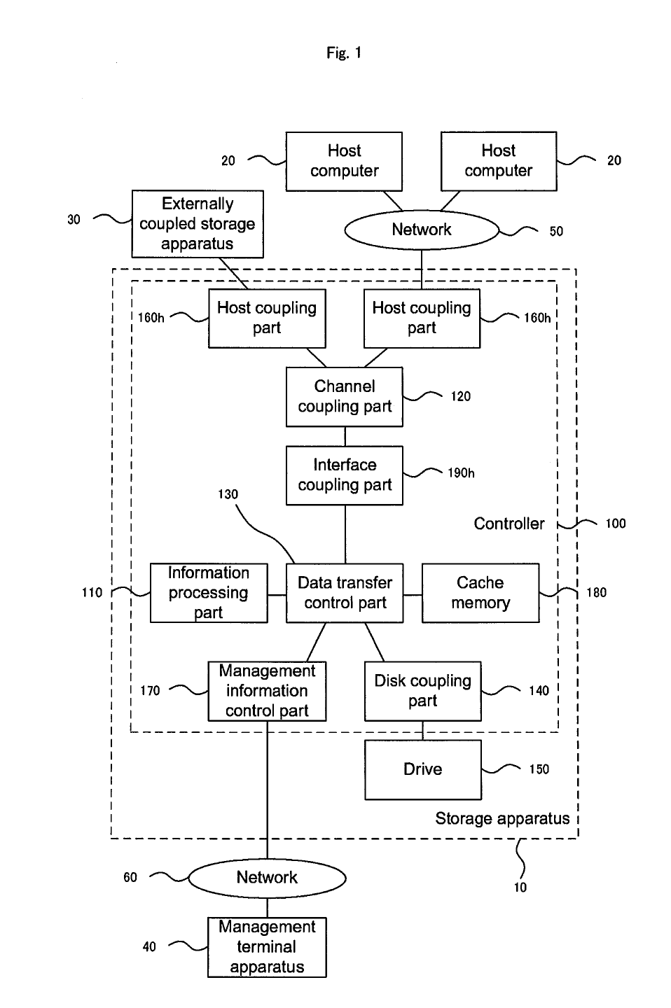

FIG. 1 shows the configuration of a storage system related to Example 1 of the present invention. This storage system comprises a storage apparatus 10, a host computer 20, an externally coupled storage apparatus 30, and a management terminal apparatus 40. The storage apparatus 10 and the host computer 20 are coupled via a network 50. The network 50, for example, is a SAN (Storage Area Network). A LAN (Local Area Network) or a WAN (Wide Area Network) may be used instead of the SAN. The storage apparatus 10 and the management terminal apparatus 40 are coupled via a network 60. The network 60, for example, is a LAN.

The host computer 20 sends the storage apparatus 10 an IO (Input/Output) request command based on a prescribed protocol. The externally coupled storage apparatus 30 is coupled to the storage apparatus 10 via a prescribed interface, and can be used by the storage apparatus 10 the same as a storage medium in the storage apparatus 10.

The management terminal apparatus 40 comprises an input device and a display device. The management terminal apparatus 40 accesses the storage apparatus 10 via the network 60 based on an input device operation by a user. The user may be the storage apparatus 10 administrator. In addition, the management terminal apparatus 40 displays data received from the storage apparatus 10 on the display device. The management terminal apparatus 40 also sends data inputted in accordance with an input device operation to the storage apparatus 10.

The storage apparatus 10 comprises a controller 100 and a drive 150. The controller 100 controls the storage apparatus 10. The controller 100 comprises an information processing part 110, a channel coupling part 120, a data transfer control part 130, a disk coupling part 140, a cache memory 180, a host coupling part 160h, a management information control part 170, and an interface coupling part 190h.

The above-mentioned front-end interface, for example, corresponds to a channel coupling part 120. The interface coupling part 190h couples the channel coupling part 120 to a data transfer control part 130. For example, the channel coupling part 120 is realized as a circuit board, the interface coupling part 190h is realized as a circuit board slot into which a connector disposed in this circuit board is inserted.

The host coupling part 160h couples the channel coupling part 120 to the network 50. The host coupling part 160h, for example, is a transceiver, such as an optical transceiver for converting an optical signal to an electrical signal.

The information processing part 110, the channel coupling part 120, the data transfer control part 130, the disk coupling part 140, the cache memory 180, and the management information control part 170 are coupled to one another via a bus. The bus, for example, is a PCI (Peripheral Component Interconnect) Express bus.

The information processing part 110 controls the storage apparatus 10. The data transfer control part 130 controls the transfer of data between elements coupled via the bus. The cache memory 180 stores data received in accordance with the data transfer control part 130. The disk coupling part 140 controls the drive 150.

The drive 150 is a HDD (Hard Disk Drive), a SSD (Solid State Drive) or other such storage device. The drive 150 is coupled to the data transfer control part 130 via the disk coupling part 140.

The management terminal apparatus 40 is coupled to the management information control part 170 via the network 50.

The management information control part 170, in addition to being coupled to the information processing part 110, is also coupled to the management terminal apparatus 40 via the network 60. The management information control part 170 creates setting screen information for configuring the channel coupling part 120 on the basis of data received from the information processing part 110, and sends the setting screen information to the management terminal apparatus 40. The management information control part 170 also sends information received from the management terminal apparatus 40 to the information processing part 110. For example, the management information control part 170 comprises a Web server, and provides the management terminal apparatus 40 with a setting screen for configuring a protocol for the channel coupling part 120. In accordance with this, the management terminal apparatus 40 comprises a Web browser, access the management information control part 170, and displays the setting screen provided from the management information control part 170. The management terminal apparatus 40, based on a user operation, sends inputted information to the management information control part 170.

In the drawings and the following explanation, the information processing part 110 may be called a MP PK (Microprocessor Package), the channel coupling part 120 may be called a CHA (Channel Adapter Package), the data transfer control part 130 may be called a SW PK (Switch Package), the disk coupling part 140 may be called a DKA (Disk Adapter), and the management information control part 170 may be called a SVP (Service Processor).

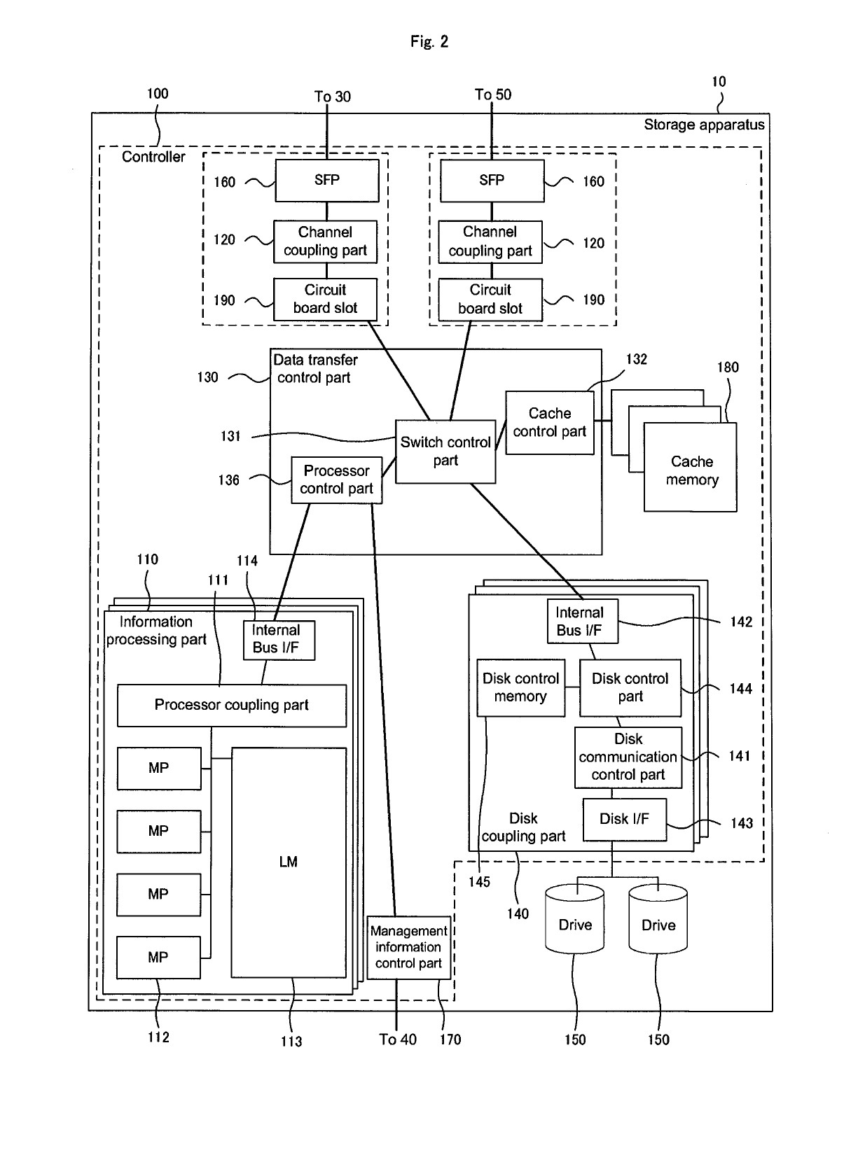

FIG. 2 shows the configuration of the storage apparatus 10 related to Example 1. The storage apparatus 10 comprises a controller 100 and at least one drive 150. The controller 100 comprises at least one information processing part 110, at least one channel coupling part 120, a data transfer control part 130, at least one disk coupling part 140, at least one drive 150, at least one SFP (Small Form-factor Pluggable) 160, a management information control part 170, at least one cache memory 180, and a circuit board slot 190. At least one SFP 160 is coupled to one channel coupling part 120. In the drawings and the following explanation, the circuit board slot 190 is used as an example of the interface coupling part 190h, and the SFP 160 is used as an example of the host coupling part 160h.

The information processing part 110 comprises a processor coupling part 111, at least one MP (microprocessor) 112, a local memory 113, and an internal bus I/F 114. In the drawings and the following explanation, the local memory 113 may be called LM.

The processor coupling part 111 couples multiple MPs 112 with the data transfer control part 130, and controls the transfer destination of data from the data transfer control part 130. The MP 112 controls the storage apparatus 10 in accordance with a program stored in the local memory 113. One MP 112 may be a single microprocessor core. The program, for example, is a protocol switching program for switching the protocol of the channel coupling part 120. The local memory 113 stores a program and data used by the MP 112. The program and data may be stored in a nonvolatile storage medium in the information processing part 110 or the drive 150. The internal bus I/F 114 controls communications between the processor coupling part 111 and the data transfer control part 130.

The data transfer control part 130 comprises a switch control part 131, a cache control part 132, and a processor control part 136.

The switch control part 131 determines the destination of data received from a certain element in the storage apparatus 10, and transfers the data to this destination. The cache control part 132 controls access to the cache memory 180. The processor control part 136 controls communications between the switch control part 131 and the information processing part 110.

The disk coupling part 140 comprises a disk communication control part 141, an internal bus I/F (Interface) 142, a disk I/F 143, a disk control part 144, and a disk control memory 145.

The internal bus I/F 142 controls communications between the data transfer control part 130 and the disk control part 144. The disk I/F 143 controls communications between the disk communication control part 141 and the drive 150. The disk control part 144 controls communications between the internal bus I/F 142 and the disk communication control part 141. The disk control memory 145 stores data and so forth received by the disk control part 144. The disk communication control part 141 controls access to the drive 150.

The SFP 160 is coupled to the channel coupling part 120 in accordance with being inserted into the SFP slot 123 of the channel coupling part 120. The SFP 160 can be inserted into and removed from the SFP slot 123 by a user. The SFP 160 comprises a connector for coupling a network 50 optical cable, and converts an electrical signal of the channel coupling part 120 to an optical signal of the optical cable and vice versa. Instead of the SFP 160, a copper wire cable or other such electrical signal cable may be coupled to the channel coupling part 120.

The channel coupling part 120 carries out communications with the host computer 20 via the network 50. The channel coupling part 120, for example, is realized using a circuit board, and is coupled to a circuit board slot of the bus in the storage apparatus 10. The channel coupling part 120 may also carry out communications with the externally coupled storage apparatus 30.

Either of a channel coupling part 120a, which is a multi-protocol board, or a channel coupling part 120b, which is a single protocol board, is used as the channel coupling part 120. The multi-protocol board supports multiple protocols for communicating with the host computer 20, and operates using one protocol, which has been configured by the MP 112 from among the multiple protocols. The single protocol board supports only one protocol for communicating with the host computer 20.

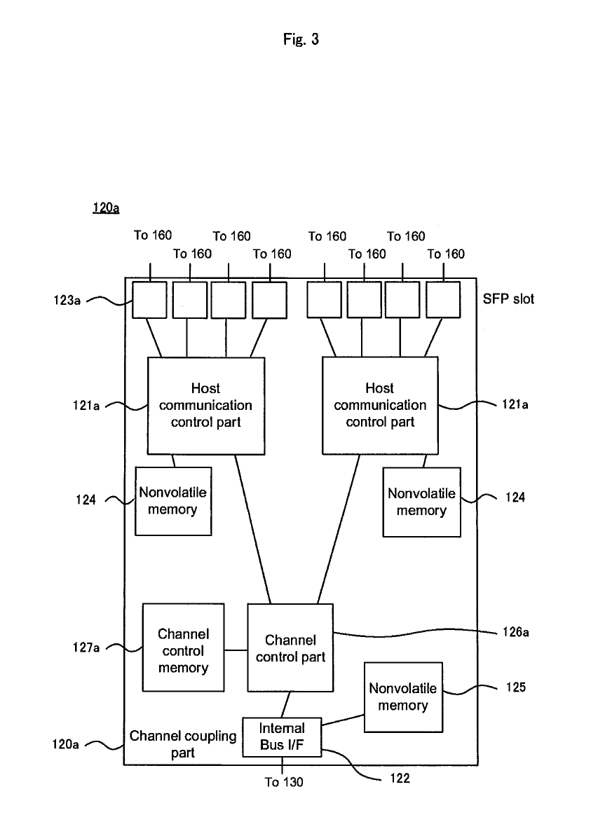

FIG. 3 shows the configuration of the channel coupling part 120a, which supports multiple protocols. The channel coupling part 120a comprises a host communication control part 121a, an internal bus I/F 122, a SFP slot 123a, a control flash memory 124, a bus flash memory 125, a channel control part 126a, and a channel control memory 127a. The channel control part 126a and the bus flash memory 125 are coupled to the internal bus I/F 122. The channel control memory 127a and at least one of the host communication control parts 121a are coupled to the channel control part 126a. At least one SFP slot 123a is coupled to one host communication control part 121a. One SFP slot 123a corresponds to one port. One control flash memory 124 is coupled to one host communication control part 121a.

The host communication control part 121a carries out communications with the host computer 20. The host communication control part 121a, for example, is realized using an IC (Integrated Circuit) chip. The control flash memory 124 stores setting information for each port of the host communication control part 121a. The setting information includes a protocol ID denoting the protocol configured in the host communication control part 121a, and a physical address configured in the host communication control part 121a. The setting information may include a device ID denoting the host communication control part 121a on the bus. In addition, the setting information may also include a timeout period, a topology, a speed, and so forth. The control flash memory 124 may be realized using another nonvolatile memory, such as another semiconductor memory or a magnetic memory. The control flash memory 124 may be realized using hardware pins, which denote the setting information. The internal bus I/F 122 controls communication between the host communication control part 121a and the data transfer control part 130. The bus flash memory 125 stores circuit board information. The circuit board information includes an interface type denoting the type of channel coupling part 120. The interface type denotes which protocol the channel coupling part 120 supports. The information processing part 110 can read the circuit board information from the bus flash memory 125 via the bus.

The host communication control part 121a stores information, such as a physical address required for network 50 communications, and information, such as a device ID required for communications inside the storage apparatus 10 in an internal volatile memory. The physical address is an address for identifying the host communication control part 121a port with respect to the network 50, and is selected from among a MAC (Media Access Control) address or WWN (World Wide Name) in accordance with the protocol. The device ID is an ID for identifying the host communication control part 121a port with respect to the bus inside the storage apparatus 10.

A default protocol may be configured beforehand for each port in the host communication control part 121a.

The channel control part 126a distributes a command received from the host computer 20 by the host communication control part 121a to any of multiple MPs 112. The channel control memory 127a stores a queue, which is used by the channel control part 126a.

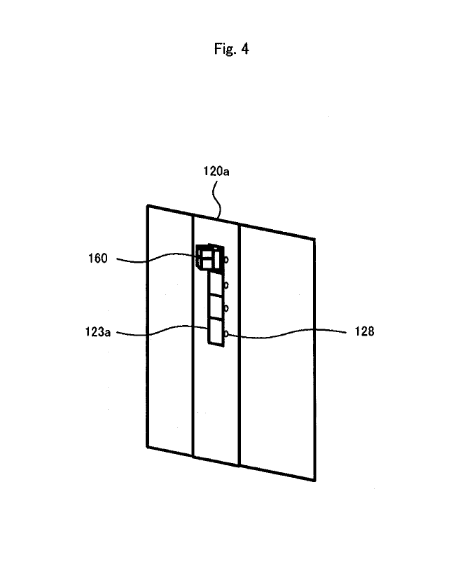

FIG. 4 shows the configuration of the SFP slot 123a. The SFP slot 123a couples a SFP 160 to the host communication control part 121a in accordance with accepting the SFP 160. The SFP slot 123a comprises a protocol display part 128, which denotes the protocol configured in the corresponding port. The protocol display part 128, for example, is a LED (Light Emitting Diode).

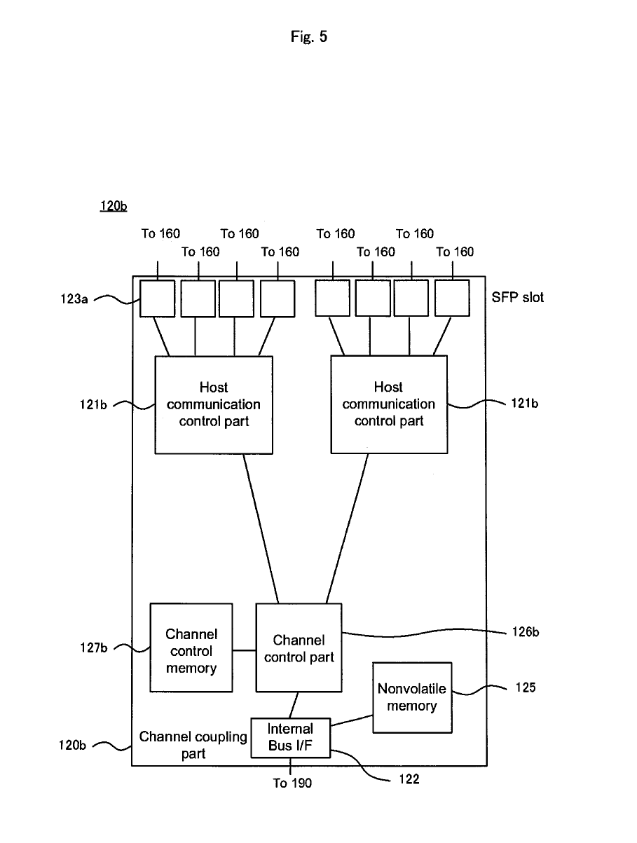

FIG. 5 shows the configuration of the channel coupling part 120b, which supports only one protocol. The channel coupling part 120b comprises a host communication control part 121b, an internal bus I/F 122, a SFP slot 123b, a bus flash memory 125, a channel control part 126b, and a channel control memory 127b. The channel control part 126b and the bus flash memory 125 are coupled to the internal bus I/F 122. The channel control memory 127b and at least one of the host communication control parts 121b are coupled to the channel control part 126b. At least one SFP slot 123b is coupled to one host communication control part 121b. One SFP slot 123b corresponds to one port.

The host communication control part 121b carries out communications with the host computer 20 in accordance with a prescribed protocol. The SFP slot 123b couples a SFP 160 to the host communication control part 121b in accordance with accepting the SFP 160.

The channel control part 126b distributes a command received from the host computer 20 by the host communication control part 121b to any of multiple MPs 112. The channel control memory 127b stores a queue, which is used by the channel control part 126b.

The channel coupling part 120 may comprise hardware pins, which are configured by the user. Setting information in accordance with the hardware pins denote a circuit board type of a specified protocol. In a case where the hardware pins are used, the channel coupling part 120 reads the setting information in accordance with the hardware pins subsequent to a hard reset, and operates using the protocol specified in this setting information.

### —Information Stored in Information Processing Part 110—

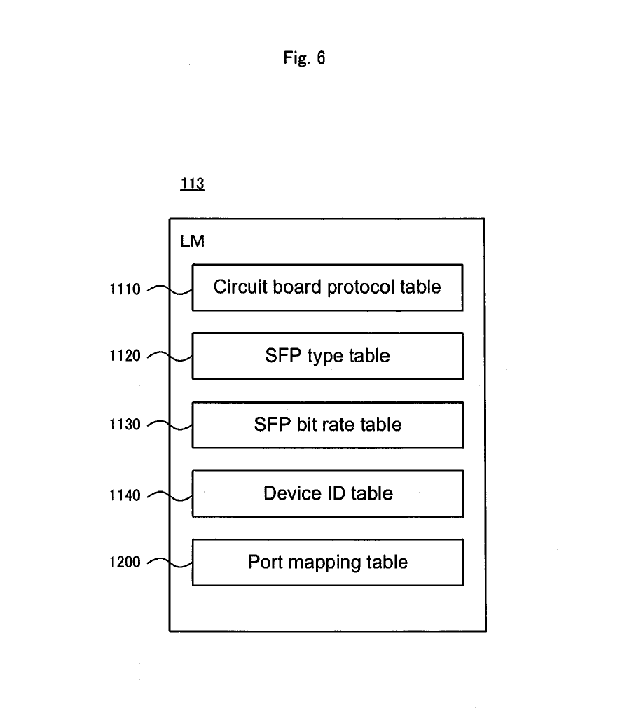

FIG. 6 shows information, which is stored in the local memory 113. The MP 112 creates a circuit board protocol table 1110, a SFP type table 1120, a SFP bit rate table 1130, a device ID table 1140, and a port mapping table 1200, and retains these tables in the local memory 113.

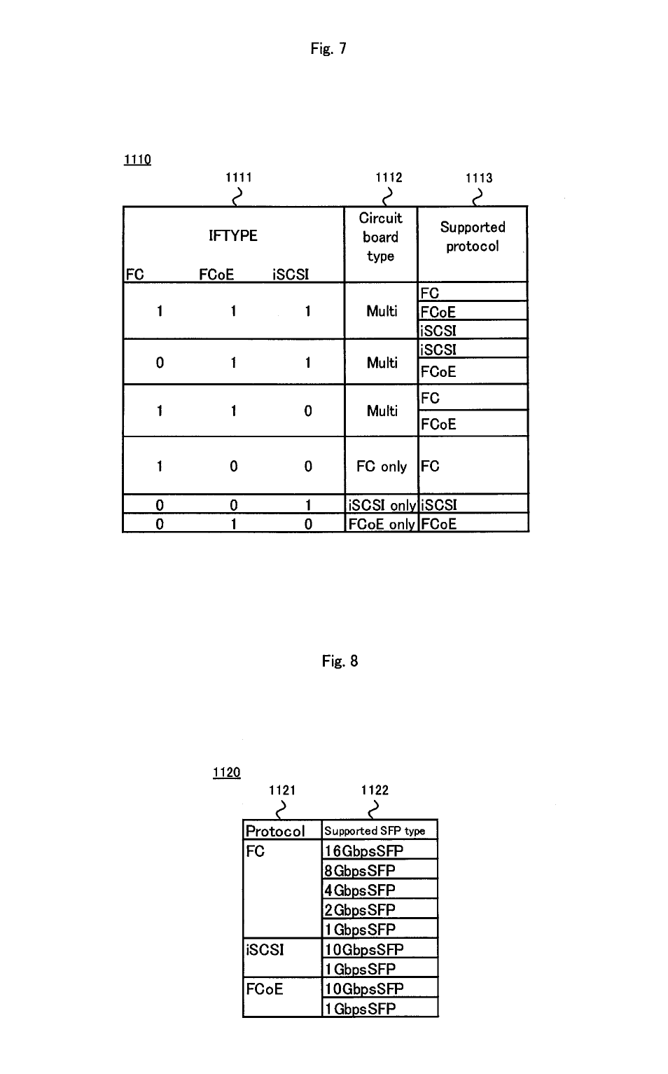

FIG. 7 shows the circuit board protocol table 1110. The circuit board protocol table 1110 comprises a circuit board type 1112 and a protocol 1113 for each interface type (IFTYPE) 1111. The interface type denotes the type of protocol supported by the channel coupling part 120, and, for example, this protocol type is denoted using three bits. The three bits correspond to FC, FCoE and iSCSI, respectively. The value of the bit for a supported protocol is 1. The circuit board type 1112 denotes the type of circuit board of the relevant channel coupling part 120. The value of the circuit board type 1112 denotes either a multi-protocol board (Multi), or the protocol (FC only, iSCSI only, FCoE only) supported in the case of a single protocol board. The protocol 1113 denotes the protocol, which is supported by the relevant channel coupling part 120.

FIG. 8 shows a SFP type table 1120. The SFP type table 1120 comprises a SFP type 1122 for each protocol 1121. The SFP type 1122, for example, is denoted by the maximum value of the SFP 160-supported bit rate.

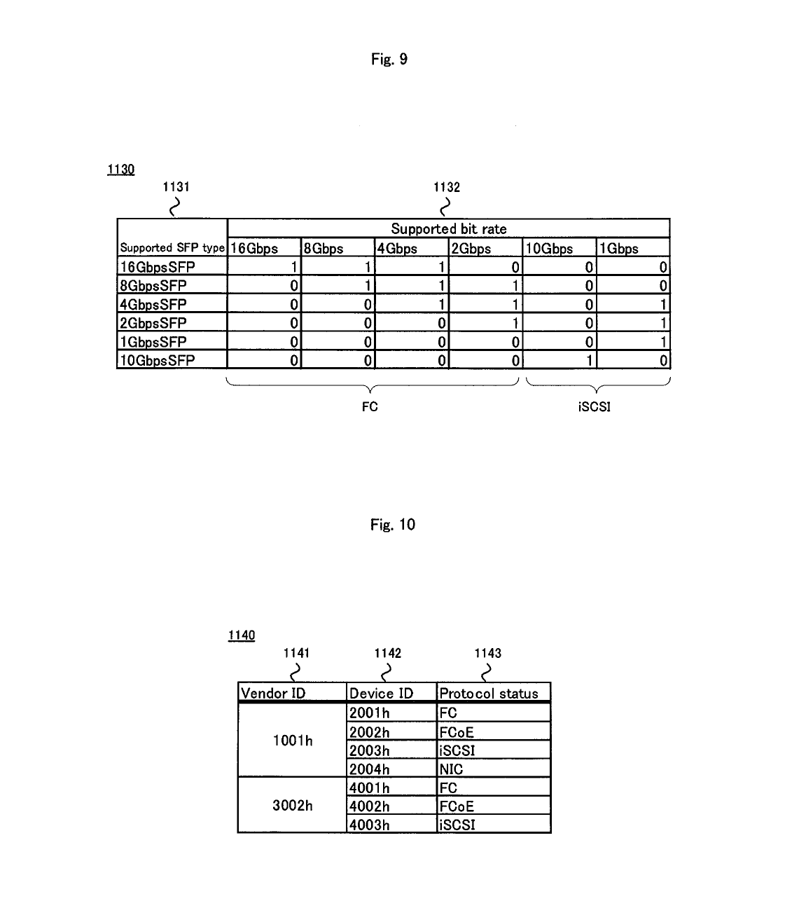

FIG. 9 shows a SFP bit rate table 1130. The SFP bit rate table 1130 comprises a supported bit rate 1132 for each SFP type 1131. The supported bit rate 1132 denotes a protocol supported by the relevant SFP type 1131 using a bit string. Multiple bit locations in the supported bit rate 1132 correspond respectively to multiple bit rates, which have been determined beforehand. The bit of a supported protocol in the supported bit rate 1132 is 1. Of the supported bit rates 1132, 16 Gbps, 8 Gbps, 4 Gbps and 2 Gbps are bit rates supported by FC, and 10 Gbps and 1 Gbps are bit rates supported by iSCSI.

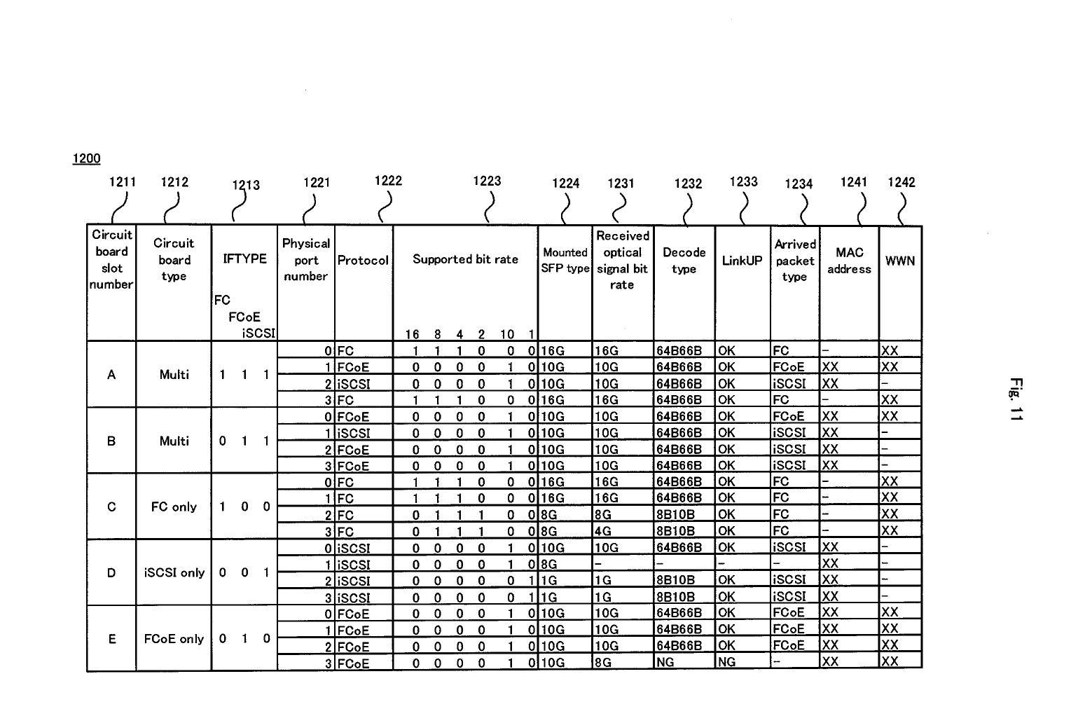

FIG. 10 shows a device ID table 1140. The device ID table 1140 comprises a vendor ID 1141, a device ID 1142, and a protocol 1143. The vendor ID 1141 denotes the vendor of the host communication control part 121a. The device ID 1142 is the ID of the device for bus communications, and is allocated to each port on the host communication control part 121a. The protocol 1143 denotes the protocol corresponding to the device ID 1142. When a protocol is configured in the port of the host communication control part 121a, the device ID corresponding to the configured protocol is allocated to this port. A different device ID 1142 value may be allocated to each port.

FIG. 11 shows a port mapping table 1200. The port mapping table 1200 comprises a circuit board slot number 1211, a circuit board type 1212, and an interface type 1213 for each channel coupling part 120. The circuit board slot number 1211 denotes the circuit board slot, of multiple circuit board slots on the bus in the storage apparatus 10, into which the relevant channel coupling part 120 circuit board is inserted. The circuit board type 1212 is the same as the circuit board type 1112 in the circuit board protocol table 1110. The interface type 1213 is the same as the interface type 1111 in the circuit board protocol table 1110.

In addition, the port mapping table 1200 denotes a physical port number 1221, a protocol 1222, a supported bit rate 1223, a mounted SFP type 1224, a received optical signal bit rate 1231, a decode type 1232, a linkUP status 1233, an arrived packet type 1234, a MAC address 1241, and a WWN 1242 for each port in the channel coupling part 120. The physical part number 1221 denotes the number of the relevant port. The protocol 1222 denotes the protocol being used by the relevant port. The supported bit rate 1223, based on data acquired from the SFP 160 inserted into the relevant port, denotes the bit rate supported by this SFP 160. Regarding this supported bit rate 1223, the method of notation for this supported bit rate 1223 is the same as the notation method of the corresponding bit rate 1132 of the SFP bit rate table 1130. The mounted SFP type 1224, based on data acquired from the SFP 160 inserted into the relevant port, denotes the SFP type of this SFP 160. The received optical signal bit rate 1231, based on a reception result of the relevant port, denotes the bit rate of the received signal. The decode type 1232, based on the reception result of the relevant port, denotes the decoding method for the received signal. The value of this decode type 1232, for example, is 64 B66 B or 8 B10 B. The linkUP status 1233, based on the reception result of the relevant port, denotes whether or not the relevant port is linked up. The arrived packet type 1234, based on the reception result of the relevant port, denotes the protocol of a packet, which has arrived at the relevant port. The MAC address 1241 denotes the MAC address being used by the relevant port. The WWN 1242 denotes the WWN being used by the relevant port.

### —Protocol Switching Process—

A protocol switching process for switching the protocol of a port will be explained hereinbelow.

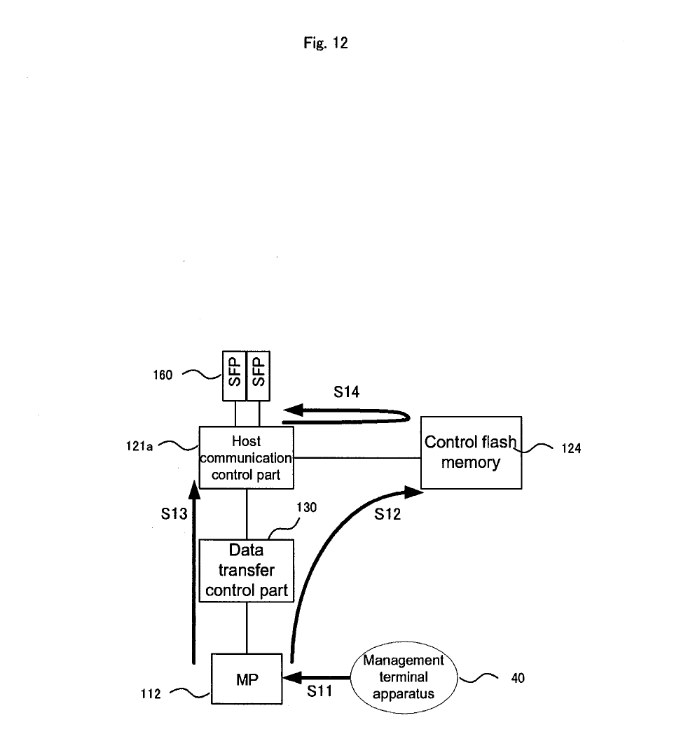

FIG. 12 schematically shows a protocol switching process.

The management terminal apparatus 40 sends a user operation-based protocol switching instruction to the MP 112 (S11). Thereafter, the MP 112 writes setting information including the identifier of the post-switch protocol to the control flash memory 124 (S12). Thereafter, the MP 112 performs a hard reset for the host communication control part 121a (S13). Thereafter, the host communication control part 121a reads the setting information from the control flash memory 124 and boots up based on the setting information (S14). In accordance with this, the host communication control part 121a operates using the post-switch protocol.

According to the above-described protocol switching process, the host communication control part 121a, in accordance with the MP 112 specifying a protocol and writing this specified protocol to the control flash memory 124, is able to configure the protocol denoted in the setting information in the control flash memory 124 and carry out communications with the network 50 in accordance with the configured protocol. This makes it possible to switch the protocol of the host communication control part 121a when the power to the channel coupling part 120a is turned ON and when the channel coupling part 120a is being energized.

The protocol switching process will be explained in detail hereinbelow.

Prior to the protocol switching process, the management information control part 170 configures and retains a usable protocol from among multiple protocols supported by the host communication control part 121a. For example, in order to obtain the right to use a certain protocol from among the multiple protocols, the user purchases the license for this protocol. In accordance with this, the management information control part 170 configures this protocol as a usable protocol by acquiring and retaining data denoting the purchased license.

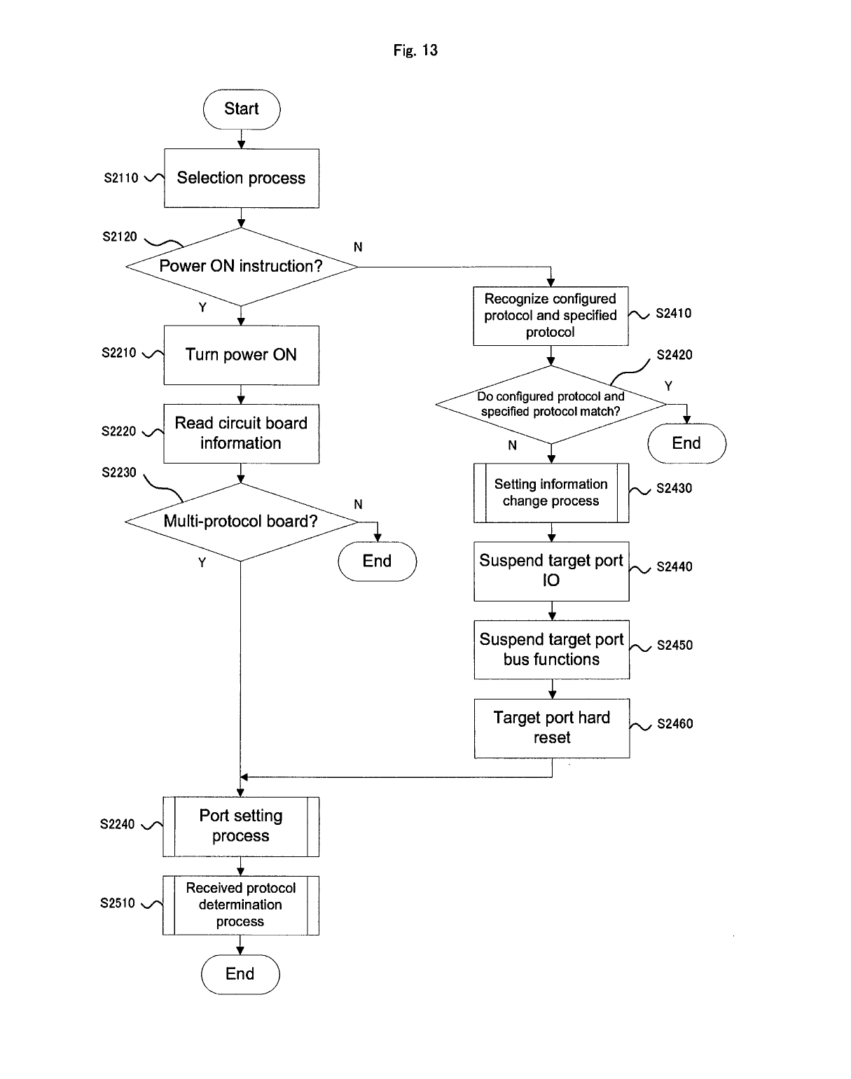

FIG. 13 shows the protocol switching process. First, the management terminal apparatus 40, based on an operation by the user, accesses the management information control part 170 and sends a selection process instruction to the management information control part 170. The management information control part 170, which receives this instruction, performs a selection process. In the selection process, the management information control part 170, on the basis of a management terminal apparatus 40 operation by the user, specifies a target port in a certain channel coupling part 120a and treats this port as the target port, and selects a protocol from the usable protocols and treats this selected protocol as the specified protocol. Thereafter, the management information control part 170 sends the MP 112 a target port ID denoting the target port, and a specified protocol ID denoting the specified protocol. At this point, the management information control part 170 may specify multiple target ports, and may select a specified protocol for each of the multiple target ports. The target port ID may be associated with the circuit board slot number of the channel coupling part 120a and the physical port number of the target port, or may include the circuit board slot number and the physical port number.

In accordance with the selection process, the MP 112 receives a target port ID and a specified protocol ID from the management information control part 170, associates the target port ID with the specified protocol ID, and writes this association to the local memory 113 (S2110). This process corresponds to S11 described hereinabove. The MP 112 treats the protocol already configured in the target port as the configured protocol, associates a configured protocol ID denoting the configured protocol with the target port ID, and retains this association in the local memory 113.

Thereafter, the MP 112 determines whether or not a power ON instruction has been received from the management information control part 170 (S2120). In a case where a power ON instruction has been received, the MP 112 turns the power to the channel coupling part 1200N, and, in addition, switches the protocol. In a case where a power ON instruction has not been received, the MP 112 switches the protocol while the channel coupling part 120 is being energized.

In a case where it has been determined that the result of S2120 described hereinabove is that a power ON instruction was received (S2120: Y), the MP 112 turns ON the power to the channel coupling part 120 (S2210). This process may turn ON the power to the entire storage system 10.

Thereafter, the MP 112 reads circuit board information from the bus flash memory 125 of the channel coupling part 120 (S2220). Thereafter, the MP 112, based on the circuit board information, determines whether or not the channel coupling part 120 is a multi-protocol board (S2230).

In a case where it has been determined that the result of S2230 described hereinabove is that the channel coupling part 120 is not a multi-protocol board, that is, a case in which the determination is that the channel coupling part 120 is a single protocol board (S2230: N), the MP 112 ends this flow without switching the protocol of the target port.

In a case where it has been determined that the result of S2230 described hereinabove is that the channel coupling part 120 is a multi-protocol board (S2230: Y), the MP 112 performs a port setting process for checking the target port (S2240). In a case where multiple target ports are specified, the MP 112 performs the port setting process for each of the multiple target ports.

Thereafter, the MP 112 performs a reception protocol determination process for determining whether or not communications between the host computer 20 and the channel coupling part 120 are normal (S2510), and ends this flow. Thereafter, communications are carried out between the host computer 20 and the storage apparatus 10.

In a case where it has been determined that the result of S2120 described hereinabove is that a power ON instruction was not received (S2120: N), the MP 112 recognizes the configured protocol and the specified protocol of the target port (S2410). For example, the MP 112 reads the target port configured protocol ID and specified protocol ID from the local memory 113. The MP 112 may also read the target port device ID from the host communication control part 121a, may recognize the configured protocol corresponding to the device ID based on the device ID table 1140, and may recognize the specified protocol by reading the port target specified protocol ID from the local memory 113.

Thereafter, MP 112 determines whether or not the configured protocol and the specified protocol are a match (S2420).

In a case where it has been determined that the result of the above-described S2420 is that the configured protocol and the specified protocol are a match (S2420: Y), the MP 112 ends this flow without switching the target port protocol.

In a case where it has been determined that the result of the above-described S2420 is that the configured protocol and the specified protocol do not match, that is, a case in which it is necessary to switch the target port protocol (S2420: N), the MP 112 performs the setting information change process described hereinabove (S2430). This process corresponds to S12 described hereinabove.

Thereafter, in accordance with issuing an instruction to the host communication control part 121a, the MP 112 suspends the IO (Input/Output) of the target part, and, in addition, continues the IO of a port other than the target port (S2440). At this point, the MP 112, for example, implements link-down for the target port. In accordance with the target port link-down, the host computer 20 can send a request to the storage apparatus 10 using another path.

Thereafter, the MP 112 suspends the bus functions with respect to the target port by issuing an instruction to the host communication control part 121a (S2450).

Thereafter, the MP 112 performs a hard reset for the target port by issuing an instruction to the host communication control part 121a (S2460), and moves the processing to S2240 described hereinabove. This process corresponds to S13 described hereinabove.

The preceding is the flow of the protocol switching process.

In the protocol switching process, the MP 112 updates the port mapping table 1200 in the local memory 113 based on data acquired from the channel coupling part 120. After the hard reset, the host communication control part 121a configures the target port specified protocol denoted in the setting information as the configured protocol, and configures the target port physical address denoted in the setting information. This process corresponds to S14 described above. In addition, the host communication control part 121a configures the device ID corresponding to the target port specified protocol. The host communication control part 121a stores a communication control program and a parameter for defining the operation of the host communication control part 121a for each protocol in internal memory. The communication control program and the parameter may be stored in the control flash memory 124. Instead of the specified protocol ID, the setting information may denote the communication control program and the parameter corresponding to the specified protocol. In the initial setting, the host communication control part 121a reads the communication control program corresponding to the target port configured protocol, and uses this communication control program to configure and boot up a protocol-specific parameter. In addition, since the memory map to be used will differ in accordance with the protocol, the host communication control part 121a allocates internal memory in accordance with the protocol and associates the port with the memory.

According to the protocol switching process, it is possible to switch the protocol of the channel coupling part 120 in accordance with a management terminal apparatus 40 operation by the user. It is possible to determine whether or not it is necessary to switch the protocol by comparing the configured protocol to the specified protocol, and in a case where it is necessary to switch the protocol, it is possible to rewrite the setting information and to the boot up the channel coupling part 120a.

### —Port Setting Process—

The port setting process in the above-described S2240 will be explained hereinbelow.

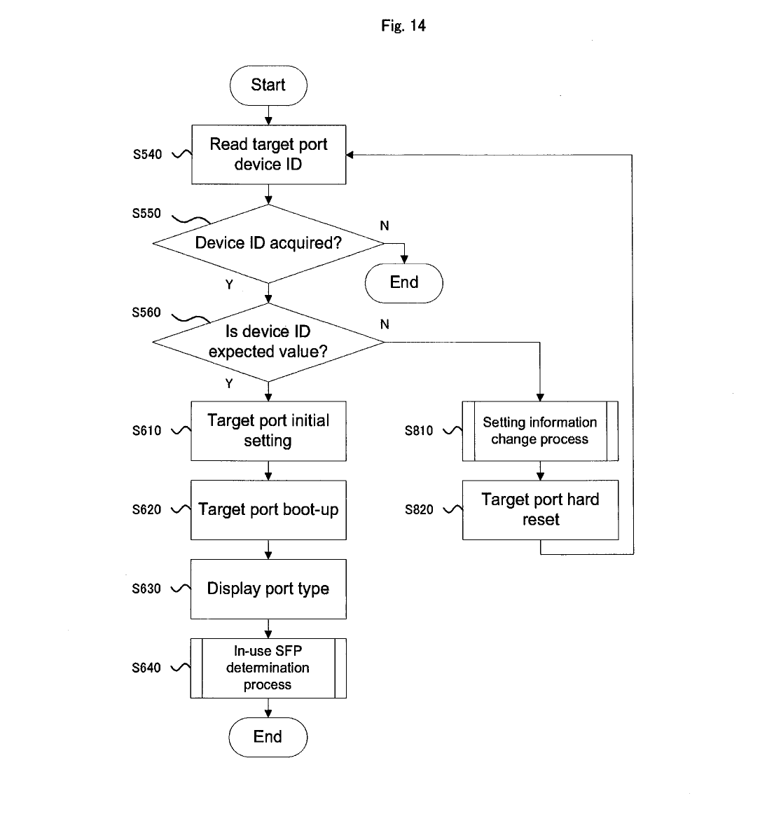

FIG. 14 shows the port setting process.

The MP 112 reads the target port device ID from the memory inside the channel coupling part 120 (S540). Thereafter, the MP 112 determines whether or not it was possible to acquire the target port device ID (S550).

In a case where it has been determined that the result of S550 is that it was not possible to acquire the target port device ID (S550: N), the MP 112 generates a bus setting error and stops this flow. The MP 112 may perform a prescribed number of retries here for reading the target port device ID.

In a case where it has been determined that the result of S550 is that it was possible to acquire the target port device ID (S550: Y), the MP 112 determines whether or not the read device ID is the expected value (S560). The expected value is one where the device ID corresponds to the target port specified protocol in the device ID table 1140. That is, a case in which the read device ID is the expected value denotes that the target port configured protocol matches the specified protocol.

In a case where it has been determined that the result of S560 described hereinabove is that the read device ID is the expected value (S560: Y), the MP 112 performs the target port initial settings (S610).

Thereafter, the host communication control part 121a performs a boot-up diagnosis for diagnosing the operation of the target port, and boots up the target port (S620).

Thereafter, the MP 112 displays the port type of the target port on the protocol display part 128 corresponding to the target port (S630). The port type, for example, is the configured protocol. The protocol display part 128, for example, comprises a LED, which is able to change colors. The SFP slot 123a in this case denotes the port type using a LED color. Or, the SFP slot 123a may comprise multiple LEDs, and may denote the port type using a combination of multiple LEDs, which are turned ON and OFF. The port type may be a SFP type or a bit rate corresponding to the configured protocol.

Thereafter, the MP 112 performs an in-use SFP determination process for determining the SFP 160 inserted into the target port SFP slot 123a (S640), and ends this flow.

In a case where it has been determined that the result of S560 described above is that the read device ID is not the expected value (S560: N), the MP 112 performs a setting information change process for changing the target port setting (S810). This process corresponds to S12 described above. Also, in a case where it has been determined that the result of S560 described above is that the read device ID is not the expected value, the MP 112 may set the target port to a blocked state, and may generate an error.

Thereafter, the MP 112 performs a target port hard reset (S820), and moves the processing to S540. This process corresponds to S13 described above.

The preceding is the flow of the port setting process.

According to the port setting process, when the host communication control part 121a boots up, the MP 112 is able to access the host communication control part 121a via the bus, and, in addition, can recognize the protocol configured in the host communication control part 121a in accordance with configuring a protocol and a corresponding device ID based on the setting information in the control flash memory 124. Also, in accordance with the SFP slot 123a displaying the configured protocol, coupling checking operations and coupling misses can be reduced. The effects of this are particularly great in a case where large numbers of cables are coupled as in a data center. After writing new setting information to the control flash memory 124, the MP 112 is able to boot up and operate the host communication control part 121a in accordance with the setting information by performing a hard reset for the host communication control part 121a.

### —Setting Information Change Process—

The setting information change process in S310 and S430 described above will be explained hereinbelow.

The setting information change process includes the translation of the physical address of the host communication control part 121a. The physical address here is a unique identifier for identifying the port of the host communication control part 121a with respect to the network 50. A physical address of a type that differs by protocol is used. In this example, the physical addresses are a MAC and a WWN. The host communication control part 121a uses a WWN as the physical address in a case where FC is used as the protocol. The host communication control part 121a uses a MAC address as the physical address in a case where iSCSI is used as the protocol. Furthermore, the host communication control part 121a uses a MAC address and a WWN as physical addresses in a case where FCoE is used as the protocol.

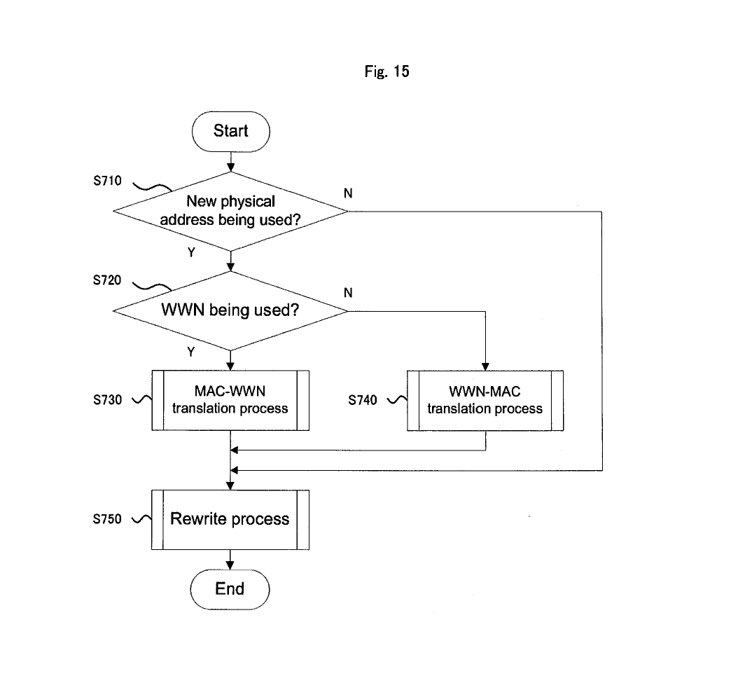

FIG. 15 shows a setting information change process.

The MP 112 determines whether or not a new physical address is used pursuant to switching the target port protocol (S710).

In a case where it has been determined that the result of S710 is that a new physical address is not being used (S710: N), the MP 112 moves the processing to S750.

In a case where it has been determined that the result of S710 is that a new physical address is being used (S710: Y), the MP 112 determines whether or not the new physical address is a WWN (S720).

In a case where it has been determined that the result of S720 is that the physical address changed from a MAC address to a WWN (S720: Y), the MP 112 performs a MAC-WWN translation process (S730), and moves the processing to S750.

In a case where it has been determined that the result of S720 is that the physical address changed from a WWN to a MAC address (S720: N), the MP 112 performs a WWN-MAC translation process (S740), and moves the processing to S750.

Subsequent to either S730 or S740, the MP 112 performs a rewrite process for rewriting the setting information in the control flash memory 124 to new setting information (S750), and ends this flow.

The preceding is the flow of the setting information change process.

According to the setting information change process, the host communication control part 121a is able to boot up based on setting information configured by the MP 112 in accordance with writing the setting information denoting the specified protocol to the control flash memory 124. Furthermore, in a case where the physical address changes pursuant to switching the protocol, it is possible to create a post-change physical address from a pre-change physical address, and to write this post-change physical address to the control flash memory 124.

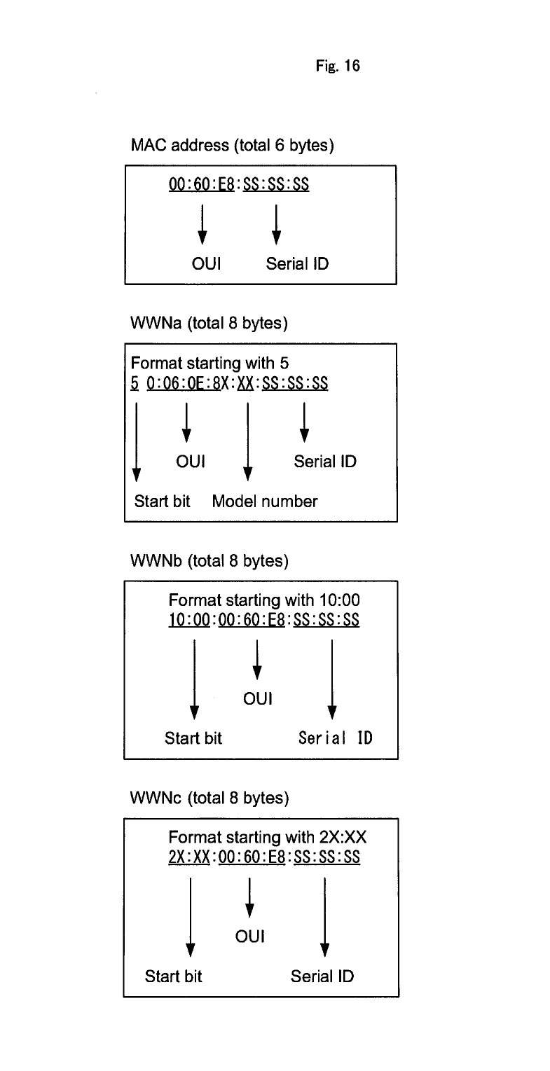

FIG. 16 shows the format of a physical address of the host communication control part 121a. In this drawing, characters other than “S” and “X” represent hexadecimals.

The length of the MAC address is six bytes. The three most significant bytes thereof are the OUI (Organizational Unique Identifier), and represent the host communication control part 121a vendor. The three least significant bytes are the serial ID of the host communication control part 121a with respect to the vendor thereof, and represent the individual host communication control part 121a.

The length of the WWN is eight bytes. Three types of WWN formats are stipulated in the WWN. In the format that begins with “5”, the three bytes subsequent thereto are the OUI, there are four bits after that, the one byte after that is a model number denoting the model of the host communication control part 121a, and the three bytes after that are a serial ID. In the following explanation and drawings, this WWN format will be called WWNa format. In the format that begins with “10:00”, the three bytes after that are the OUI, and the three bytes after that are a serial ID. In the following explanation and drawings, this WWN format will be called WWNb format. In the format that begins with “2X:XX”, the three bytes after that are the OUI, and the three bytes after that are a serial ID. In the following explanation and drawings, this WWN format will be called WWNc format.

Therefore, the three least significant bytes in all MAC addresses and WWNs are the serial ID.

The MAC-WWN translation process via which the MP 112 creates a WWN from a MAC address will be explained here.

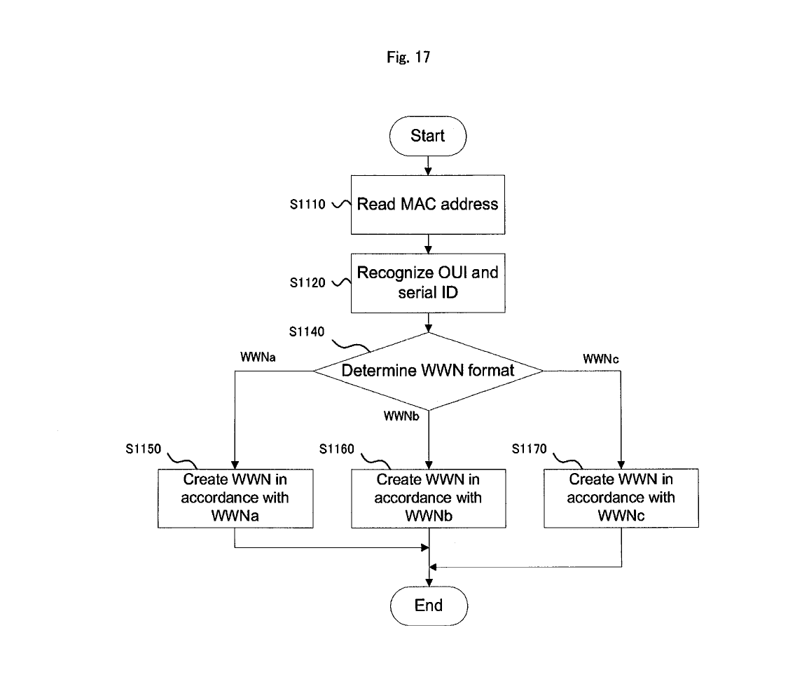

FIG. 17 shows the MAC-WWN translation process.

The MP 112 reads the six-byte MAC address from the control flash memory 124 (S1110).

Thereafter, the MP 112 recognizes the least significant three-byte serial ID and the most significant three-byte OUI from the read MAC address (S1120).

Thereafter, the MP 112 references the local memory 113 and determines whether the format determined beforehand for the host communication control part 121a is any of the WWNa format, the WWNb format, or the WWNc format (S1140).

In a case where it has been determined that the recognized format is the WWNa format (S1140: “5”), the MP 112 creates an eight-byte WWN from the recognized OUI and serial ID in accordance with the WWNa format, writes this eight-byte WWN to the local memory 113 (S1150), and ends this flow.

In a case where it has been determined that the recognized format is the WWNb format (S1140: “10:00”), the MP 112 creates an eight-byte WWN from the recognized OUI and serial ID in accordance with the WWNb format, writes this eight-byte WWN to the local memory 113 (S1160), and ends this flow.

In a case where it has been determined that the recognized format is the WWNc format (S1140: “2X:XX”), the MP 112 creates an eight-byte WWN from the recognized OUI and serial ID in accordance with the WWNc format, writes this eight-byte WWN to the local memory 113 (S1170), and ends this flow.

The preceding is the flow of the MAC-WWN translation process.

The WWN-MAC translation process via which the MP 112 creates a MAC address from a WWN will be explained here.

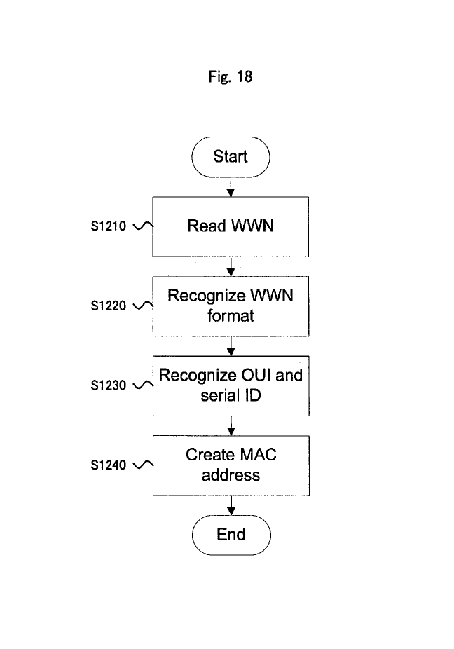

FIG. 18 shows the WWN-MAC translation process.

The MP 112 reads an eight-byte WWN from the control flash memory 124 (S1210).

Thereafter, the MP 112 references the local memory 113 and recognizes the WWN format determined beforehand for the host communication control part 121a (S1220). The MP 112 may also recognize the WWN format in the read WWN.

Thereafter, the MP 112 recognizes the least significant three-byte serial ID and the most significant three-byte OUI in accordance with the recognized format (S1230).

Thereafter, the MP 112 creates a six-byte MAC address from the recognized OUI and serial ID, writes this MAC address to the local memory 113 (S1240), and ends this flow.

The preceding is the flow of the WWN-MAC translation process.

A rewrite process for the MP 112 to rewrite the setting information in the control flash memory 124 will be explained here.

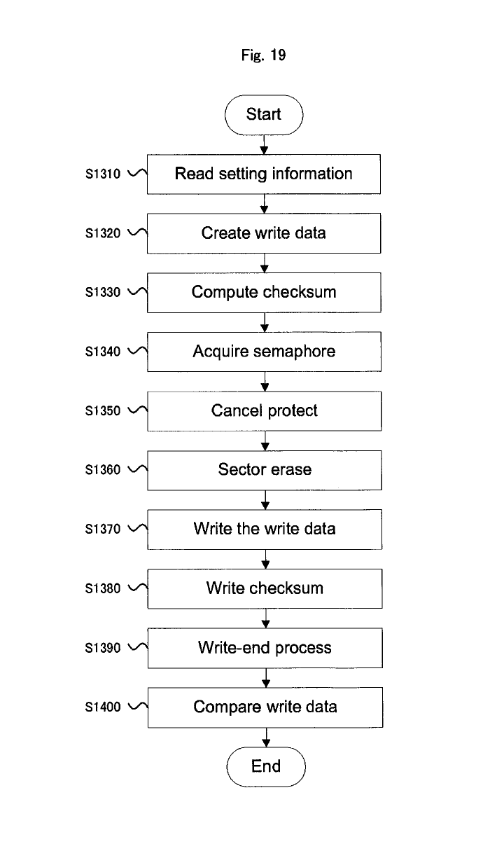

FIG. 19 shows the rewrite process.

The MP 112 reads the setting information in the control flash memory 124, and saves (backs up) this setting information to the local memory 113 (S1310).

Thereafter, the MP 112 creates write data for the control flash memory 124 by changing only the target port information of the setting information saved to the local memory 113, and writes this write data to the local memory 113 (S1320). The post-change information of the target port includes the target port specified protocol ID and at least either a MAC address or a WWN. The write data may include the ID of the device corresponding to the specified protocol.

Thereafter, the MP 112 computes a write data checksum, and writes this checksum to the local memory 113 (S1330).

Thereafter, the MP 112 acquires the control flash memory 124 semaphore (S1340).

Thereafter, the MP 112 cancels the control flash memory 124 protect (S1350).

Thereafter, the MP 112 performs a control flash memory 124 sector erase (S1360).

Thereafter, the MP 112 writes the write data to the control flash memory 124 (S1370).

Thereafter, the MP 112 writes the checksum to the control flash memory 124 (S1380).

Thereafter, the MP 112 performs a write-end process for the control flash memory 124 (S1390). The write-end process includes an unprotect and a semaphore release.

Thereafter, the MP 112 reads the write data in the control flash memory 124, compares this write data to the write data in the local memory 113 (S1400), and ends this flow. In a case where the results of the comparison do not match, the MP 112 re-executes the rewrite process.

The preceding is the flow of the rewrite process.

According to the rewrite process, it is possible to change the settings of the target port alone by reading the setting information from the control flash memory 124, changing only the target port information of the setting information, and writing the changed setting information to the control flash memory 124.

### —In-Use SFP Determination Process—

An in-use SFP determination process for determining the SFP 160 in the SFP slot 123 in S640 described above will be explained below.

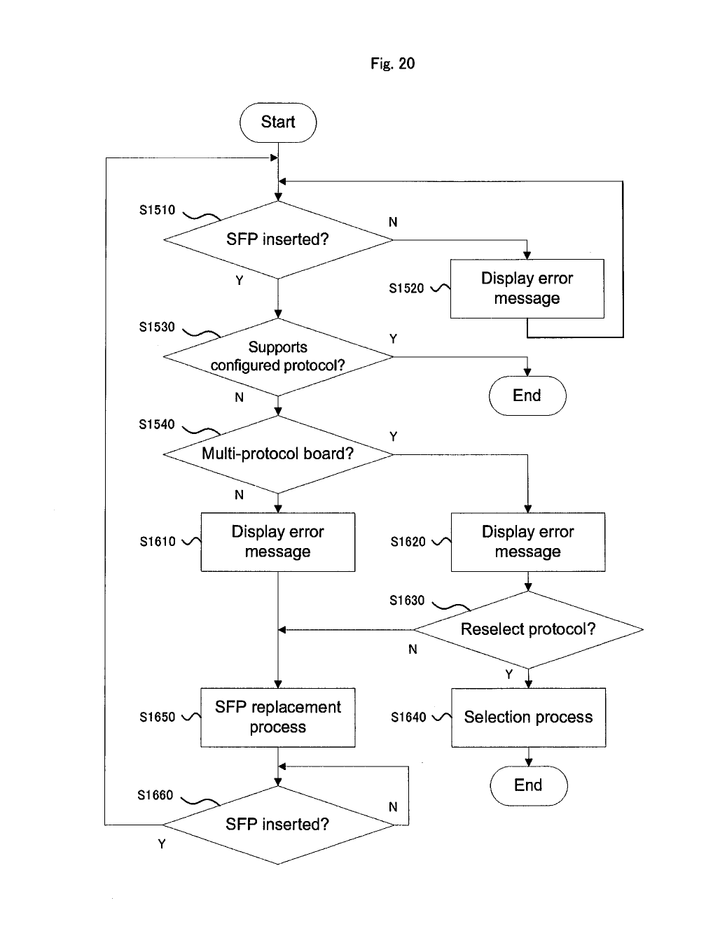

FIG. 20 shows the in-use SFP determination process.

The MP 112 determines whether or not a SFP 160 is inserted into the target port SFP slot 123 (S1510).

In a case where it has been determined that a SFP 160 is not inserted into the target port SFP slot 123 (S1510: N), the MP 112 displays an error message on the management terminal apparatus 40 via the management information control part 170, waits for a prescribed time (S1520), and moves the processing to S1510.

In a case where it has been determined that a SFP 160 is inserted into the target port SFP slot 123 (S1510: Y), the MP 112 recognizes the supported protocol of the SFP 160, and determines whether or not the SFP 160 supports the configured protocol (S1530). At this point, the MP 112, for example, acquires the type of the SFP 160 in accordance with the I2C (Inter-Integrated Circuit) coupling, and recognizes the supported protocol based on the acquired type.

In a case where it has been determined that the SFP 160 supports the configured protocol (S1530: Y), that is, a case in which it has been determined that the SFP 160 is compatible with the configured protocol, the MP 112 ends this flow.

In a case where it has been determined that the SFP 160 does not support the configured protocol (S1530: N), the MP 112 determines whether or not the channel coupling part 120 is a multi-protocol board (S1540).

In a case where it has been determined that the result of S1540 is that the channel coupling part 120 is a single protocol board (S1540: N), the MP 112 displays an error message on the management terminal apparatus 40 via the management information control part 170 (S1610), and moves the processing to S1650. The error message here, for example, is a message urging the user to replace the SFP 160, such as “SFP does not match selected protocol. Please replace SFP.”

In a case where it has been determined that the result of S1540 is that the channel coupling part 120 is a multi-protocol board (S1540: Y), the MP 112 displays an error message on the management terminal apparatus 40 via the management information control part 170 (S1620). The error message here, for example, is a message urging the user to either replace the SFP 160 or reselect the protocol, such as “SFP does not match selected protocol. Please either replace SFP or reselect protocol.” Thereafter, the MP 112 determines whether or not an instruction received from the management information control part 170 based on a management terminal apparatus 40 operation by the user is an instruction to reselect the protocol (S1630).

In a case where it has been determined that the instruction received from the management information control part 170 is a protocol reselection instruction (S1630: Y), the MP 112 performs the selection process (S1640) and ends this flow.

In a case where it has been determined that the instruction received from the management information control part 170 is not a protocol reselection instruction, that is, in a case where the instruction denotes the replacement of the SFP 160 (S1630: N), or subsequent to S1610, the MP 112 performs an SFP replacement process, which allows the user to replace the SFP 160 (S1650).

Thereafter, the MP 112 determines whether or not the SFP 160 has been replaced (S1660).

In a case where the SFP 160 has yet to be replaced (S1660: N), the MP 112 waits until the SFP 160 is replaced by moving the processing to S1660.

In a case where it has been determined that the SFP 160 was replaced (S1660: Y), the MP 112 moves the processing to S1510.

The preceding is the flow of the in-use SFP determination process.

According to the in-use SFP determination process, it is possible to prevent the occurrence of a failure resulting from an SFP 160-coupling or protocol-selection error by making sure that an SFP 160, which supports the user-selected protocol, is inserted in the SFP slot 123.

A variation of the in-use SFP determination process will be explained here. In a case where the channel coupling part 120 comprises hardware pins, a hardware pins determination process for checking the hardware pins is performed prior to the in-use SFP determination process.

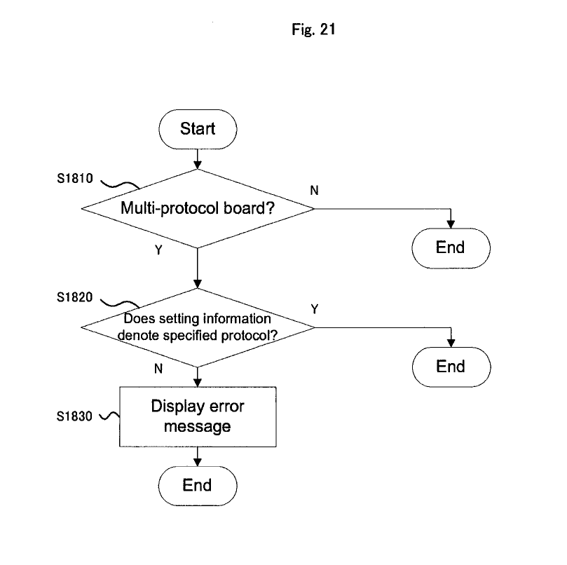

FIG. 21 shows the hardware pins determination process.

The MP 112 acquires circuit board information from the bus flash memory 125 of the channel coupling part 120, and determines whether or not the acquired circuit board information denotes a multi-protocol board (S1810).

In a case where it has been determined that the result of S1810 is that the circuit board information denotes a single protocol board (S1810: N), the MP 112 ends this flow.

In a case where it has been determined that the result of S1810 is that the circuit board information denotes a multi-protocol board (S1810: Y), the MP 112 determines whether or not the setting information configured in accordance with the hardware pins of the channel coupling part 120 denotes the specified protocol (S1820).

In a case where it has been determined that the result of S1820 is that the setting information denotes the specified protocol (S1820: Y), the MP 112 ends this flow.

In a case where it has been determined that the result of S1820 is that the setting information does not denote the specified protocol (S1820: N), the MP 112 displays an error message on the management terminal apparatus 40 via the management information control part 170 (S1830), and ends this flow. The error message here is a message urging the user to reselect the protocol.

According to the hardware pins determination process, it is possible to check whether or not the protocol configured in the host communication control part 121a using hardware pins match the specified protocol.

### —Reception Protocol Determination Process—

A reception protocol determination process for the MP 112 to determine the protocol of a signal received from the host computer 20 in S2150 described above will be explained hereinbelow. The reception protocol determination process is performed subsequent to the above-described the port setting process.

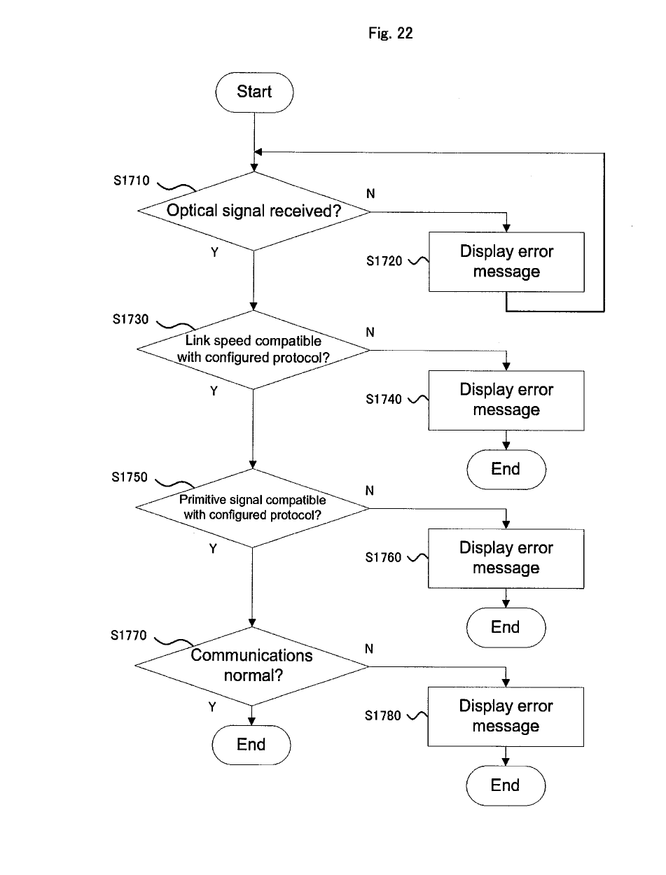

FIG. 22 shows the reception protocol determination process.

The MP 112 determines whether or not the SFP 160 is receiving an optical signal (S1710).

In a case where it has been determined that the SFP 160 is not receiving an optical signal (S1710: N), the MP 112 displays an error message on the management terminal apparatus 40 via the management information control part 170 (S1720), and moves the processing to S1710.

In a case where it has been determined that the SFP 160 is receiving an optical signal (S1710: Y), the MP 112 determines whether or not the link speed of the received signal is compatible with the selected protocol (S1730). At this point, the MP 122 determines that the link speed is compatible with the configured protocol when the received signal is able to be decoded at the link speed specified by the configured protocol.

In a case where it has been determined that the received signal link speed is not compatible with the configured protocol (S1730: N), the MP 112 displays an error message on the management terminal apparatus 40 via the management information control part 170 (S1740), and ends the flow.

In a case where it has been determined that the received signal link speed is compatible with the configured protocol (S1730: Y), the MP 112 determines whether or not the primitive signal inside the received signal is compatible with the configured protocol (S1750). Here the MP 112 determines whether the primitive signal inside the received signal denotes Ethernet or FC.

In a case where it has been determined that the primitive signal inside the received signal is not compatible with the configured protocol (S1750: N), the MP 112 displays an error message on the management terminal apparatus 40 via the management information control part 170 (S1760), and ends this flow. The error message here, for example, is a message urging the user to check the protocol setting, such as “Protocol differs from that of coupling destination. Please check protocol setting (FC or Ethernet).”

In a case where it has been determined that the primitive signal inside the received signal is compatible with the configured protocol (S1750: Y), the MP 112 determines whether or not communications in accordance with the selected protocol are normal (S1770). At this point, the MP 112 determines that communications using the selected protocol are normal in a case where packet communications have been performed using the selected protocol and the linkUP sequence ended normally.

In a case where it has been determined that normal communications are not possible using the selected protocol (S1770: N), the MP 112 displays an error message on the management terminal apparatus 40 via the management information control part 170 (S1780) and ends this flow.

In a case where it has been determined that communications using the selected protocol are normal (S1770: Y), the MP 112 ends this flow.

According to the reception protocol determination process, it is possible to prevent the occurrence of a failure resulting from an Initiator-coupling or a protocol-selection error by checking to make sure the received signal is supported by the user-selected protocol.

### —Setting Screen—

Screen transitions (a first screen transition through a third screen transition) of a setting screen displayed by the management terminal apparatus 40 will be explained below.

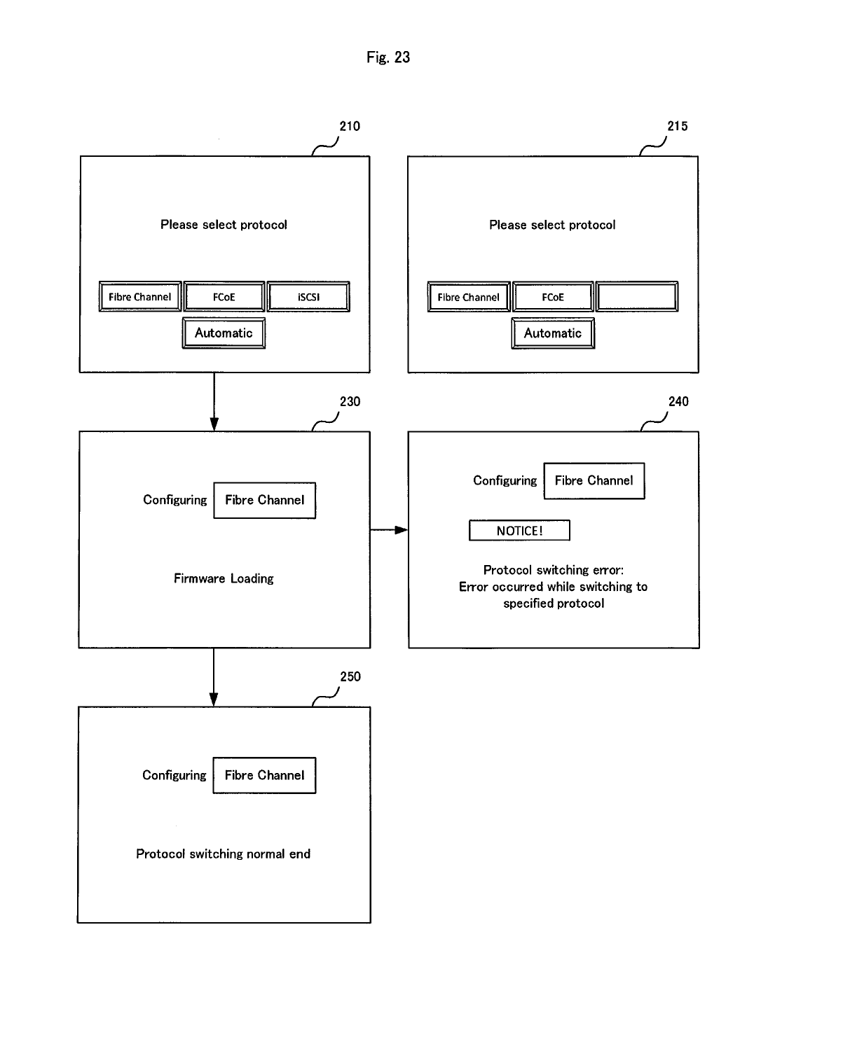

FIG. 23 shows a first screen transition in the protocol switching process.

In the selection process described above, the management information control part 170 displays a protocol selection screen 210 on the management terminal apparatus 40. The protocol selection screen 210 denotes multiple protocols supported by the target port as protocol options. The protocol selection screen 210 may comprise an “automatic” button for executing an automatic selection process. The automatic selection process will be explained further below as a variation of the selection process. The management terminal apparatus 40, in accordance with a user operation, selects the specified protocol from among the usable protocols in the protocol selection screen 210. Instead of the protocol selection screen 210, a screen like protocol selection screen 215 may be used to make it impossible to select an unusable protocol by not displaying an unusable protocol, or denoting a protocol as being unusable by making the display of an unusable protocol lighter.

In a case where the specified protocol selected using the protocol selection screen 210 is a usable protocol, port setting processing is performed up to S630 in the above-described protocol switching process. During that time, the management information control part 170 displays a loading screen 230 on the management terminal apparatus 40. The loading screen 230, for example, denotes that the specified protocol is being loaded into the target port.

Thereafter, the management information control part 170 determines whether or not an error has occurred in the protocol switching process. The error here, for example, is a case in which it was determined in the above-described S560 that the read device ID is not the expected value and the target port transitioned to a blocked state. In a case where an error has occurred in the protocol switching process, the management information control part 170 displays an error screen 240 on the management terminal apparatus 40. The error screen 240, for example, denotes that an error has occurred while switching to the specified protocol.

In a case where the port setting process up to S630 was completed normally, and the port type of the target port has been displayed in accordance with the LED of the SFP slot 123, the management information control part 170 displays the loading complete screen 250 on the management terminal apparatus 40. The loading complete screen 250, for example, denotes that the specified protocol has been configured as the configured protocol in the target port and loading has been completed.

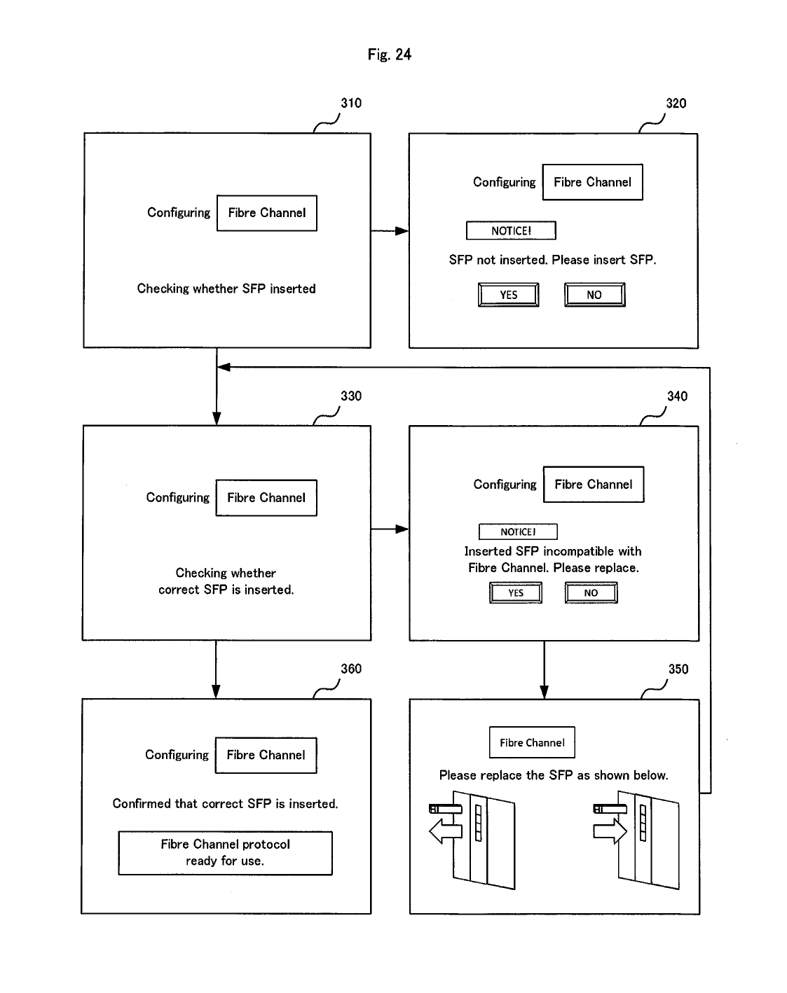

FIG. 24 shows a second screen transition in the protocol switching process.

Thereafter, the in-use SFP determination process is performed in S640 of the port setting process. In S1510 of the in-use SFP determination process, the management information control part 170 displays a SFP check screen 310 on the management terminal apparatus 40. The SFP check screen 310, for example, denotes that a check is in progress as to whether or not a SFP is inserted in the SFP slot 123.

In a case where it has been determined in accordance with S1510 that a SFP is not inserted in the SFP slot 123, the management information control part 170 displays an error screen 320 on the management terminal apparatus 40. The error screen 320, for example, includes a message urging the user to insert a SFP, such as “SFP not inserted. Please insert SFP.”.

In a case where it has been determined in accordance with S1510 that a SFP is inserted in the SFP slot 123, in S1530 of the in-use SFP determination process, the management information control part 170 displays a SFP type check screen 330 on the management terminal apparatus 40. The SFP type check screen 330, for example, denotes that a check is in progress as to whether or not a SFP, which supports the configured protocol, is inserted in the SFP slot 123.

In a case where it has been determined in accordance with S1530 that a SFP supporting the configured protocol is not inserted in the SFP slot 123, the management information control part 170 displays an error screen 340 on the management terminal apparatus 40. The error screen 340, for example, includes a message denoting that an SFP, which is not compatible with the configured protocol, is inserted, and urging the user to replace the SFP, such as “Inserted SFP incompatible with FC. Please replace.”.

Thereafter, in a case where the SFP is replaced in accordance with S1650, the management information control part 170 displays a replacement procedure screen 350 on the management terminal apparatus 40. The replacement procedure screen 350, for example, illustrates the procedure for replacing the SFP.

Either subsequent to the SFP type check screen 330 or the replacement procedure screen 350, or in a case where it has been determined in accordance with S1530 that an SFP, which does not support the configured protocol, is inserted in the SFP slot 123, the management information control part 170 displays a confirmation screen 360 on the management terminal apparatus 40. The confirmation screen 360, for example, denotes that an SFP, which supports the configured protocol, is inserted in the SFP slot 123.

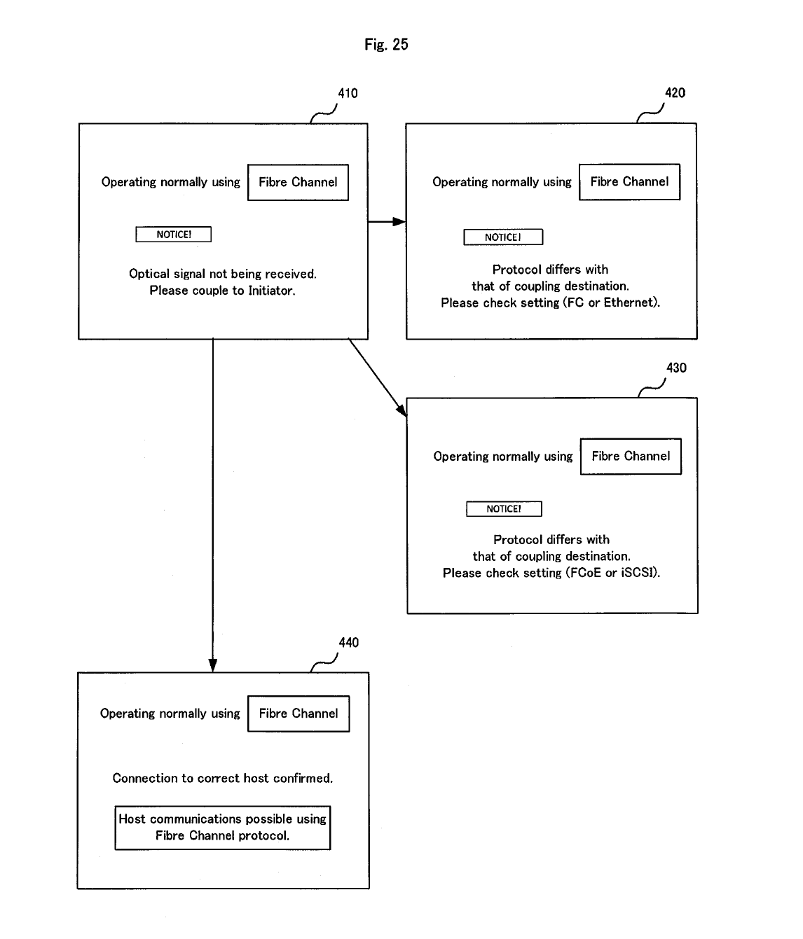

FIG. 25 shows a third screen transition in the protocol switching process.

Thereafter, a reception protocol determination process of the protocol switching process is performed. In a case where it has been determined in accordance with S1710 of the reception protocol determination process that the SFP 160 is not receiving an optical signal, the management information control part 170 displays an error screen 410 on the management terminal apparatus 40. The error screen 410, for example, denotes that the SFP 160 is not receiving an optical signal, and includes a message urging the user to couple the SFP 160 to the initiator.

Thereafter, either in a case where it has been determined in accordance with S1730 that the received signal link speed does not match the selected protocol, or in a case where it has been determined in accordance with S1750 that the primitive signal inside the received signal does not match the selected protocol, the management information control part 170 displays an error screen 420 on the management terminal apparatus 40. The error screen 420, for example, includes a message urging the user to check the protocol setting, such as “Protocol differs from that of coupling destination. Please check setting (FC or Ethernet).”.

In a case where it has been determined in accordance with S1770 that normal communications are not possible using the selected protocol, the management information control part 170 displays an error screen 430 on the management terminal apparatus 40. The error screen 430, for example, includes a message urging the user to check the protocol setting, such as “Protocol differs from that of coupling destination. Please check setting (FCoE or iSCSI)”

In a case where it has been determined in accordance with S1770 that normal communications are possible using the selected protocol, the management information control part 170 displays a normal operation screen 440 on the management terminal apparatus 40, and ends the protocol switching process. The normal operation screen 440, for example, includes a message denoting confirmation of the fact that the coupling destination supports the configured protocol, such as “Operating normally using FC. Connection to correct host confirmed. Host communications possible using FC protocol.”.

The preceding are the screen transitions of the management terminal apparatus 40.

According to the screen transitions of the management terminal apparatus 40, the user is able to select a channel coupling part 120 protocol in accordance with a screen of the management terminal apparatus 40. Furthermore, in a case where a problem occurs, such as the SFP inserted into the target port or the target port coupling destination not being compatible with the configured protocol, the management terminal apparatus 40 can solve this problem by showing the user a solution to the problem.

### —Communication Control Process—

A communication control process in a case where the storage apparatus 10 receives an IO request command from the host computer 20 subsequent to target port communications having been confirmed as normal in accordance with the protocol switching process will be explained hereinbelow. The IO is either a read or a write.

The configuration in the storage apparatus 10 for receiving an IO request command from the host computer 20 will be explained here.

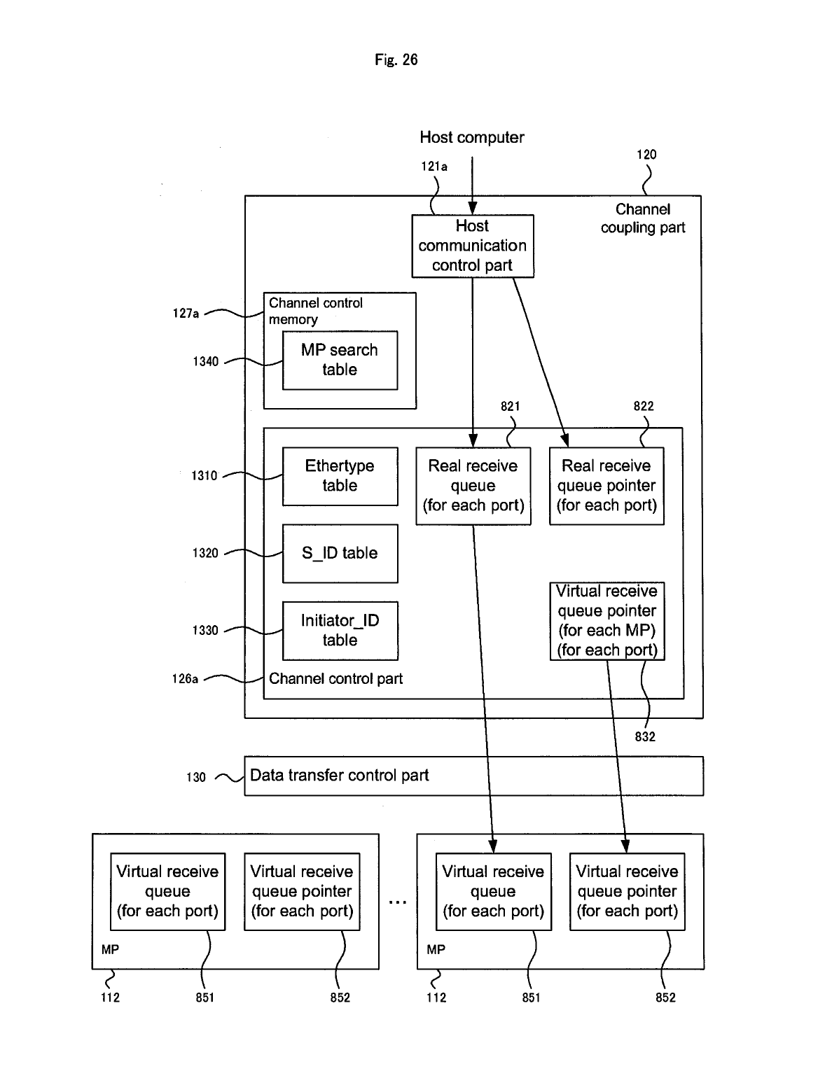

FIG. 26 shows the configuration in the storage apparatus 10 for receiving a command. The channel control part 126a stores in internal memory a real receive queue 821 for each port, a real receive queue pointer 822 for each port, a virtual receive queue pointer 832 for each combination of a port and a MP 112, an Ethertype table 1310, a S_ID table 1320, and an Initiator_ID table 1330. The channel control memory 127a stores a MP search table 1340. Each of multiple MPs 112 comprises a virtual receive queue 851 for each port and a virtual receive queue pointer 852 for each port. The virtual receive queue 851 and the virtual receive queue pointer 852 may be stored in the local memory 113.

A MP number is allocated to each of the multiple MPs 112.

A command, which is sent from the host computer 20 to the storage apparatus 10 using any of the iSCSI, FC, or FCoE protocols, includes a source ID denoting the source of the command and a LUN (Logical Unit Number) denoting the IO request target storage area in the storage apparatus 10. In the iSCSI, the source ID is the Initiator_ID. In the FC or FCoE, the source ID is the S_ID. In the following explanation, an S_ID table 1320 and an Initiator_ID table 1330 may be called a source ID table. In addition, the command in a case where the protocol uses Ethernet includes Ethertype.

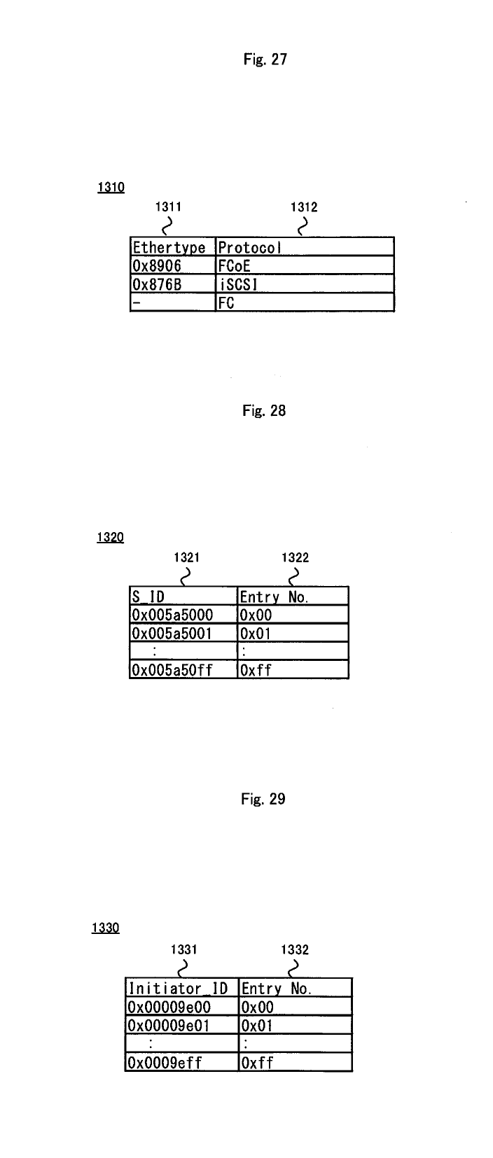

FIG. 27 shows an Ethertype table 1310. The Ethertype table 1310 comprises an Ethertype 1311 and a protocol 1312 corresponding thereto. With regards to the Ethertype table 1310, the protocol 1312 is FC in a case where there is no Ethertype 1311 value, that is, a case in which an Ethertype is not included in the command.

FIG. 28 shows a S_ID table 1320. The S_ID table 1320 comprises a S_ID 1321 and an entry number 1322 corresponding thereto. The S_ID 1321 denotes the source of a command in accordance with FC or FCoE. The entry number 1322 is denoted in an MP search table 1340.

FIG. 29 shows an Initiator_ID table 1330. The Initiator_ID table 1330 comprises an Initiator_ID 1331 and an entry number 1332 in the MP search table 1340. The Initiator_ID 1331 denotes the source of a command in accordance with iSCSI. The entry number 1332 is denoted in the MP search table 1340.

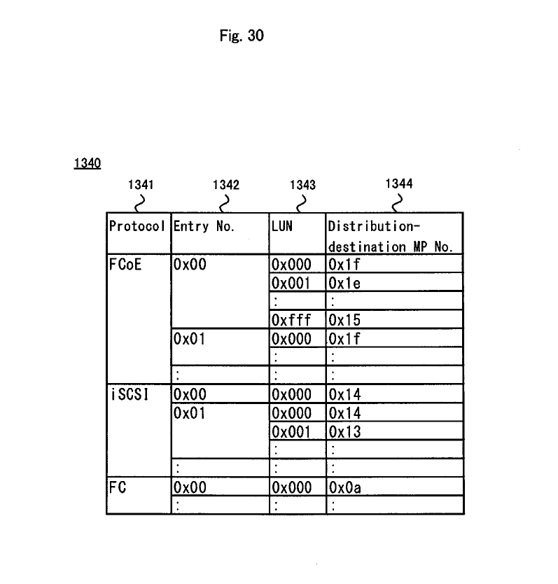

FIG. 30 shows the MP search table 1340. The MP search table 1340 comprises a protocol 1341, an entry number 1342, a LUN 1343, and a MP number 1344. At least one entry number 1342 is associated with one protocol 1341. The entry number 1342 corresponds to a command-source host computer 20. At least one LUN 1343 is associated with one entry number 1342. The LUN 1343 is included in the command, and denotes the target storage area of the IO request thereof. One MP number 1344 is associated with one LUN 1343. The MP number 1344 denotes the MP 112, which is the command distribution destination (transfer destination).

The channel control part 126a selects from among multiple MPs 112 a destination for the command transferred from the host computer 20 to the host communication control part 121a, and transfers the command to the selected destination. The real receive queue 821 stores the received command in accordance with the corresponding port. The real receive queue pointer 822 denotes the current input/output location in the corresponding real receive queue 821. The virtual receive queue 851 stores the command transferred from the channel control part 126a to the MP 112. The virtual receive queue pointer 832 and the virtual receive queue pointer 852 denote the current input/output location in the corresponding virtual receive queue 851.

A receive control process via which the channel coupling part 120 transfers a command from the host computer 20 to the MP 112 will be explained here.

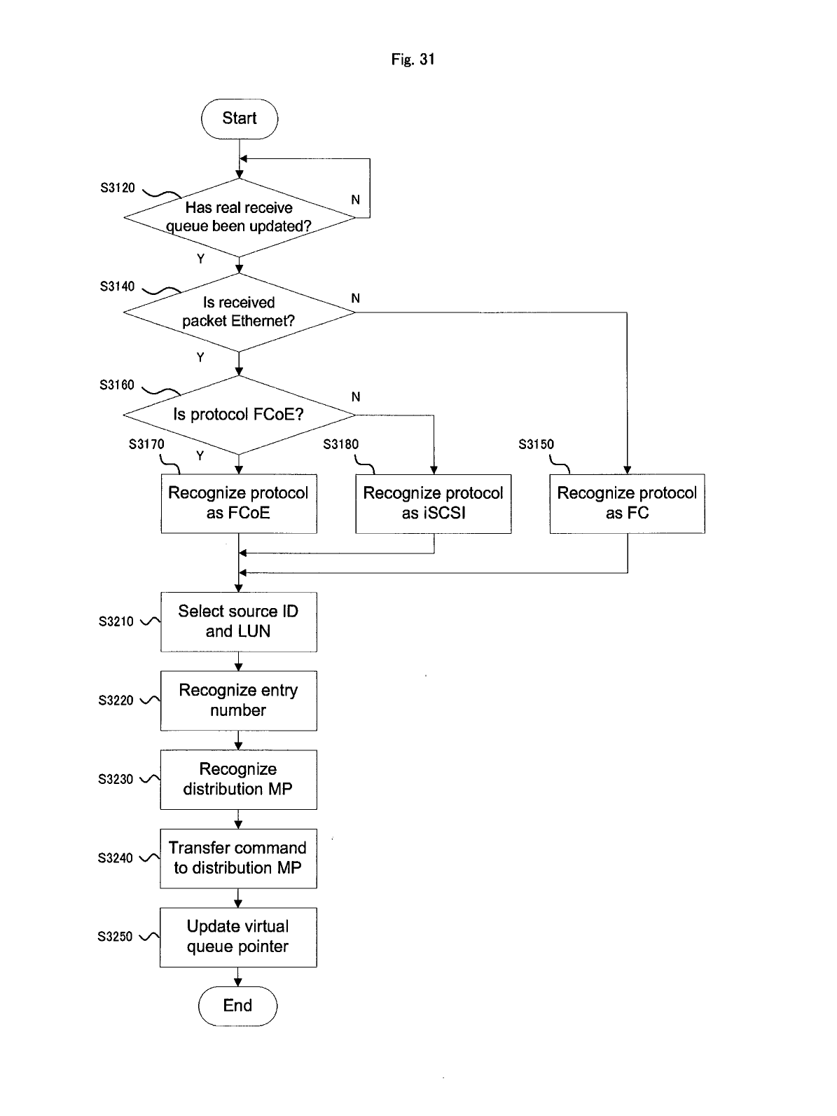

FIG. 31 shows a receive control process. Upon receiving a command from the host computer 20, the host communication control part 121a transfers the received command to the real receive queue 821 and updates the real receive queue pointer 822. The channel control part 126a performs the receive control process.

The channel control part 126a determines whether or not the real receive queue 821 has been updated (S3120).

In a case where it has been determined that the result of S3120 is that the real receive queue 821 was not updated (S3120: N), the channel control part 126a moves the processing to S3120. In accordance with this, the channel control part 126a waits for the real receive queue 821 to be updated.

In a case where it has been determined that the result of S3120 is that the real receive queue 821 of a certain port was updated (S3120: Y), the channel control part 126a determines based on the Ethertype whether or not a received packet is Ethernet (S3140). In a case where the Ethertype has been detected from the received packet here, the channel control part 126a determines that the received packet is Ethernet.

In a case where it has been determined that the result of S3140 is that the received packet is not Ethernet (S3140: N), the channel control part 126a recognizes that the protocol of the received packet is FC (S3150), and moves the processing to S3210.

In a case where it has been determined that the result of S3140 is that the received packet is Ethernet (S3140: Y), the channel control part 126a references the Ethertype table 1310, and based on the Ethertype, determines whether or not the protocol of the received packet is FCoE (S3160).

In a case where it has been determined that the result of S3160 is that the protocol of the received packet is FCoE (S3160: Y), the channel control part 126a recognizes that the protocol of the received packet is FCoE (S3170), and moves the processing to S3210.

In a case where it has been determined that the result of S3160 is that the protocol of the received packet is not FCoE (S3160: Y), the channel control part 126a recognizes that the protocol of the received packet is iSCSI (S3180), and moves the processing to S3210.

Subsequent to S3150, S3170, or S3180, the channel control part 126a selects a source ID and a LUN from the command parameters (S3210).

Thereafter, the channel control part 126a recognizes the entry number corresponding to the source ID in accordance with referencing the source ID table (S3220).

Thereafter, the channel control part 126a recognizes the MP number corresponding to a combination of the determined protocol, the recognized entry number, and the LUN inside the command in accordance with referencing the MP search table 1340, and recognizes the MP 112 corresponding to the recognized MP number as the distribution-destination MP (S3230).

Thereafter, the channel control part 126a transfers the command to the target port virtual receive queue 851 address in the distribution-destination MP (S3240).

Thereafter, the channel control part 126a updates its own target port virtual receive queue pointer 832 and the target port virtual queue pointer 852 in the distribution-destination MP (S3250), and ends this flow.

The preceding is the flow of the receive control process.

The channel control part 126a may select the distribution-destination MP based on at least any of the IO request protocol, the IO request source, or the IO request storage area.

A request receive process via which the MP 112 receives a command will be explained here.

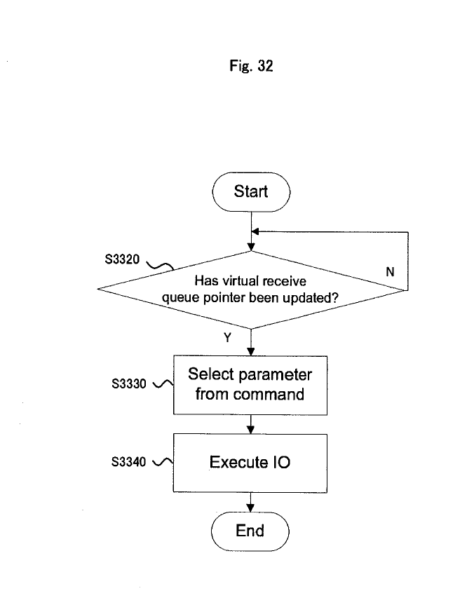

FIG. 32 shows the request receive process.

The MP 112 determines whether or not the virtual receive queue pointer 852 has been updated (S3320).

In a case where it has been determined that the result of S3320 is that the virtual receive queue pointer 852 has not been updated (S3320: N), the MP 112 moves the processing to S3320. In accordance with this, the MP 112 waits for the virtual receive queue pointer 852 to be updated.

In a case where it has been determined that the result of S3320 is that the virtual receive queue pointer 852 has been updated (S3320: Y), the MP 112 selects a parameter required for IO from the command (S3330).

Thereafter, the MP 112 uses the parameter to execute the IO (S3340) and ends this flow.

The preceding is the flow of the request receive process.

The configuration for the storage apparatus 10 to send the host computer 20 a response with respect to a command will be explained here.

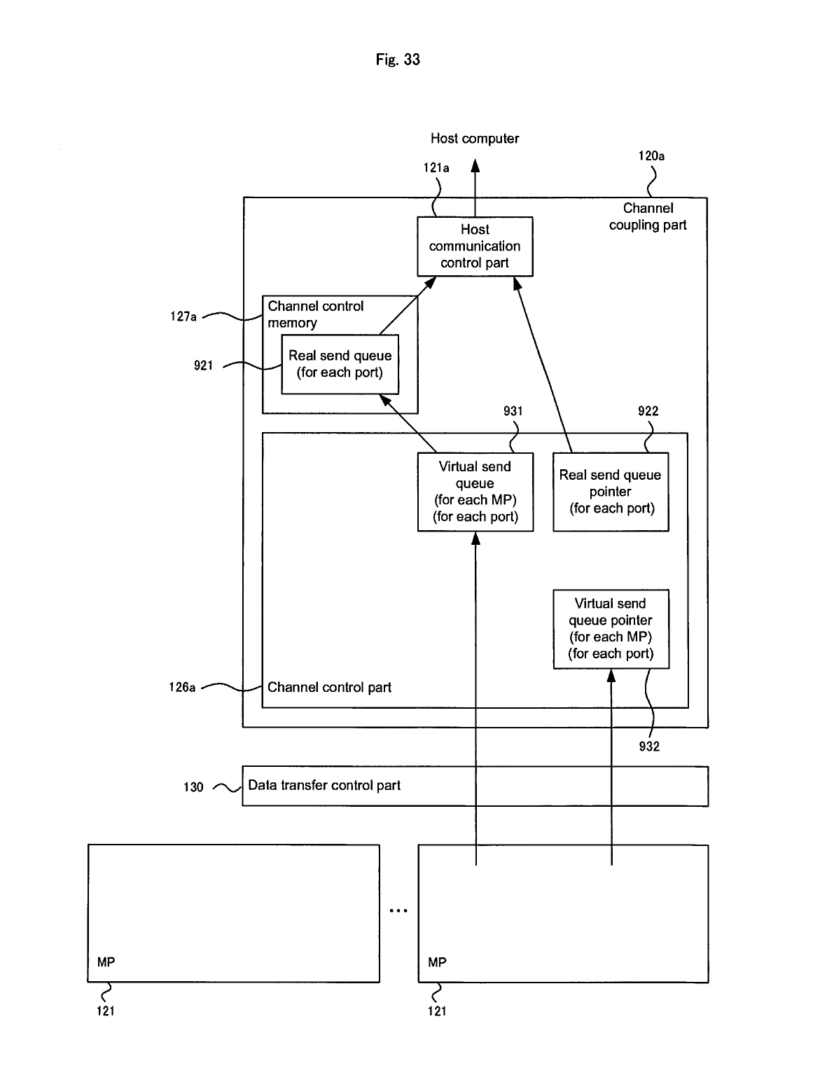

FIG. 33 shows the configuration in the storage apparatus 10 for sending a response. The channel control part 126a stores in internal memory a real send queue pointer 922 for each port, a virtual send queue 931 for each combination of a port and a MP 112, and a virtual send queue pointer 932 for each combination of a port and a MP 112. The channel control memory 127a stores the real send queue 921 for each port.

The channel control part 126a transfers a response, which has been transferred from the MP 112 to the channel control part 126a, to the host communication control part 121a. The virtual send queue 931 stores the response transferred from the MP 112 to the channel control part 126a. The virtual send queue pointer 932 denotes the current input/output location in the corresponding virtual send queue 931. The real send queue 921 stores the response to the corresponding port. The real send queue pointer 922 denotes the current input/output location in the corresponding real send queue 921.

A response send process via which the MP 112 sends a response with respect to a command will be explained here. This response send process, for example, is performed when the protocol is FC.

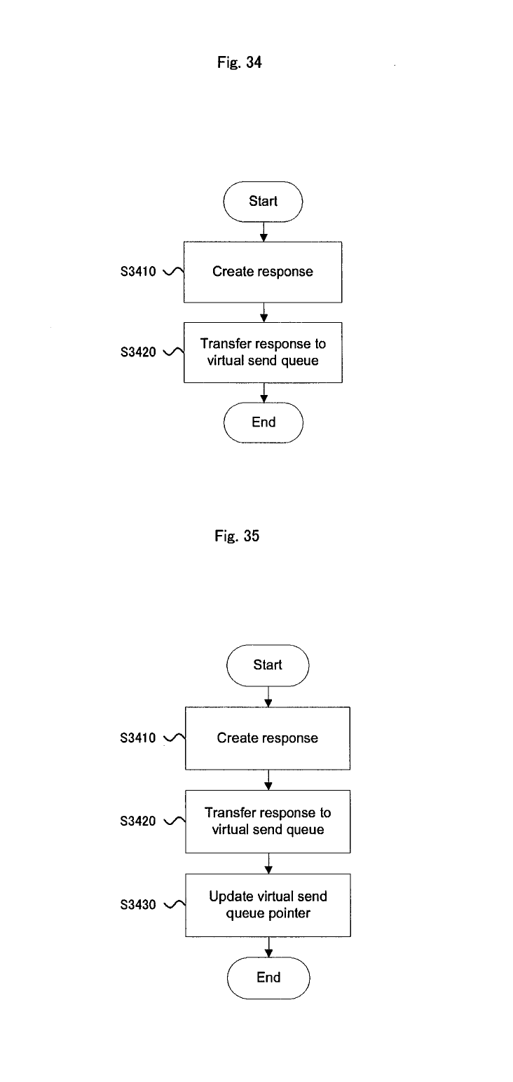

FIG. 34 shows the response send process.

The MP 112 creates a response based on the result of an IO (S3410).

Thereafter, the MP 112 transfers the response to the virtual send queue 931 corresponding to its own MP and the target port (S3420) and ends this flow.

The MP 112, in accordance with writing to the virtual send queue 931, notifies the channel control part 126a of the updating of the virtual send queue 931.

The preceding is the flow of the response send process.

A variation of the response send process will be explained here. This variation of the response send process, for example, is performed when the protocol is FCoE.

FIG. 35 shows the variation of the response send process.

The MP 112 creates a response based on an IP result (S3410).

Thereafter, the MP 112 transfers the response to the virtual send queue 931 corresponding to its own MP and the target port (S3420).

Thereafter, the MP 112 updates the virtual send queue pointer 932 corresponding to its own MP and the target port (S3430) and ends this flow.

At this point, the MP 112 notifies the channel control part 126a of the updating of the virtual send queue 931 in accordance with updating the virtual send queue pointer 932.

The preceding is the flow of the variation of the response send process.

A send control process via which the channel coupling part 120 transfers a response from the MP 112 to the host computer 20 will be explained here.

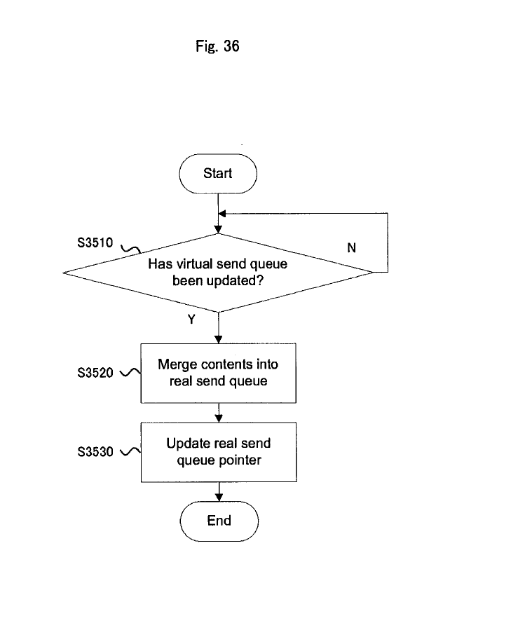

FIG. 36 shows a send control process.

The channel control part 126a determines whether or not the virtual send queue 931 has been updated (S3520).

In a case where it has been determined that the result of S3520 is that the virtual send queue 931 has not been updated (S3520: N), the channel control part 126a moves the processing to S3520. In accordance with this, the channel control part 126a waits for the virtual send queue 931 to be updated.

In a case where it has been determined that the result of S3520 is that the virtual send queue 931 corresponding to a certain port and a certain MP 112 has been updated (S3520: Y), the channel control part 126a merges the contents of the updated virtual send queue 931 with the real send queue 921 in the order in which the contents were updated (S3530).

Thereafter, the channel control part 126a updates the real send queue pointer 922 corresponding to the updated real send queue 921, and, in addition, updates the corresponding queue pointer in the host communication control part 121a (S3530) and ends this flow.

The preceding is the flow of the send control process.

The channel control part 126b selects a distribution-destination MP 112 the same as the channel control part 126a, but the distribution-destination MP 112 becomes the only MP 112 corresponding to a prescribed protocol.

According to the above-described communication control process, the operation of the MP 112 is limited to the operation of a protocol and a storage area determined beforehand in the MP search table 1340. This makes it possible to simplify the operation of the MP 112 even in a storage apparatus 10, which supports multiple protocols, and to reduce the load on the MP 112. Furthermore, this communication control process can also be applied in a case where the storage apparatus 10 receives a request other than an IO request from the host computer 20.

### Example 2

In this example, a storage system comprising a smaller scale (either a medium or small) storage apparatus than the storage apparatus of Example 1 will be explained.

### —Configuration of Storage Apparatus of Example 2—

The configuration of a storage apparatus of Example 2 will be explained below.

A storage system of Example 2 comprises a storage apparatus 10p instead of the storage apparatus 10 in Example 1. In Example 2, an element having the same reference sign as an element of Example 1 is either the same or equivalent to the element of Example 1, and an explanation thereof will be omitted here.

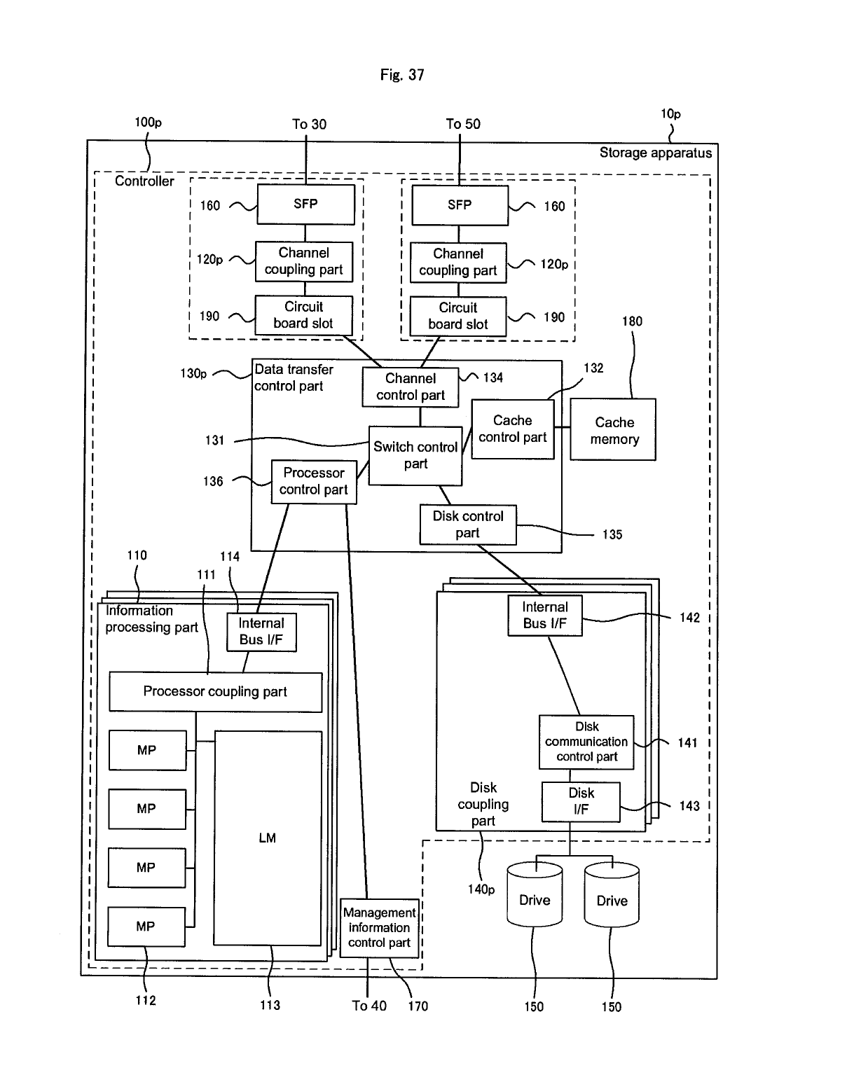

FIG. 37 shows the configuration of the storage apparatus 10p related to Example 2. The storage apparatus 10p comprises a controller 100p instead of the controller 100 of Example 1, comprises a channel coupling part 120p instead of the channel coupling part 120 of Example 1, and comprises a disk coupling part 140p instead of the disk coupling part 140 of Example 1. The controller 100p comprises a data transfer control part 130p instead of the data transfer control part 130 of Example 1.

The data transfer control part 130p comprises a switch control part 131, a cache control part 132, a channel control part 134, and a disk control part 135. The disk control part 135 controls communications between the switch control part 131 and the disk coupling part 140. The channel control part 134 controls communications between the switch control part 131 and the channel coupling part 120. The channel control part 134 also comprises the functions of the channel control part 126a and the channel control memory 127a of Example 1. This makes it possible to distribute a command received from the host computer 20 to multiple MPs 112. The disk control part 135 includes elements equivalent to the disk control part 144 and the disk control memory 145. In accordance with this, a disk coupling part 140p does not include the disk control part 144 and the disk control memory 145.

Multiple cache memories 180 are coupled to the cache control part 132.

Either a channel coupling part 120c, which is a multi-protocol board, or a channel coupling part 120d, which is a single protocol board, is used as the channel coupling part 120p.

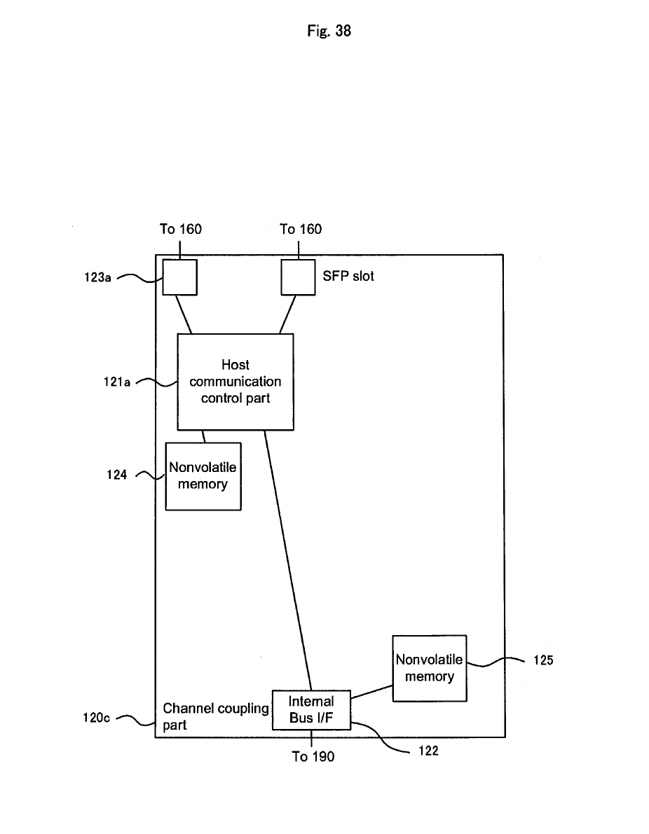

FIG. 38 shows the configuration of the channel coupling part 120c, which supports multiple protocols. The channel coupling part 120c comprises a host communication control part 121a, an internal bus I/F 122, a SFP slot 123a, a control flash memory 124, and a bus flash memory 125. The host communication control part 121a and the bus flash memory 125 are coupled to the internal bus I/F 122. At least one SFP slot 123a is coupled to the host communication control part 121a. That is, the channel coupling part 120c does not require the channel control part 126a and the channel control memory 127a in the channel coupling part 120a of Example 1.

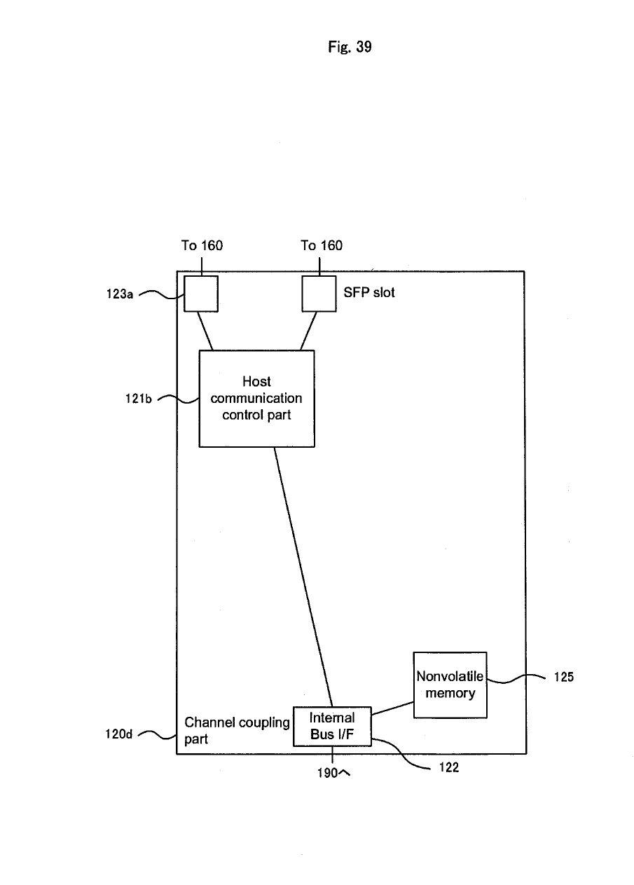

FIG. 39 shows the configuration of the channel coupling part 120d, which supports only one protocol. The channel coupling part 120d comprises a host communication control part 121b, an internal bus I/F 122, a SFP slot 123b, and a bus flash memory 125. The host communication control part 121b and the bus flash memory 125 are coupled to the internal bus I/F 122. At least one SFP slot 123b is coupled to the host communication control part 121b. That is, the channel coupling part 120d does not require the channel control part 126b and the channel control memory 127b in the channel coupling part 120b of Example 1.

According to this example, the scale of the circuitry in the channel coupling part 120p of this example can be made smaller than the scale of the circuitry in the channel coupling part 120 of Example 1.

### —Variation of Protocol Switching Process—

A variation of the protocol switching process will be explained hereinbelow.

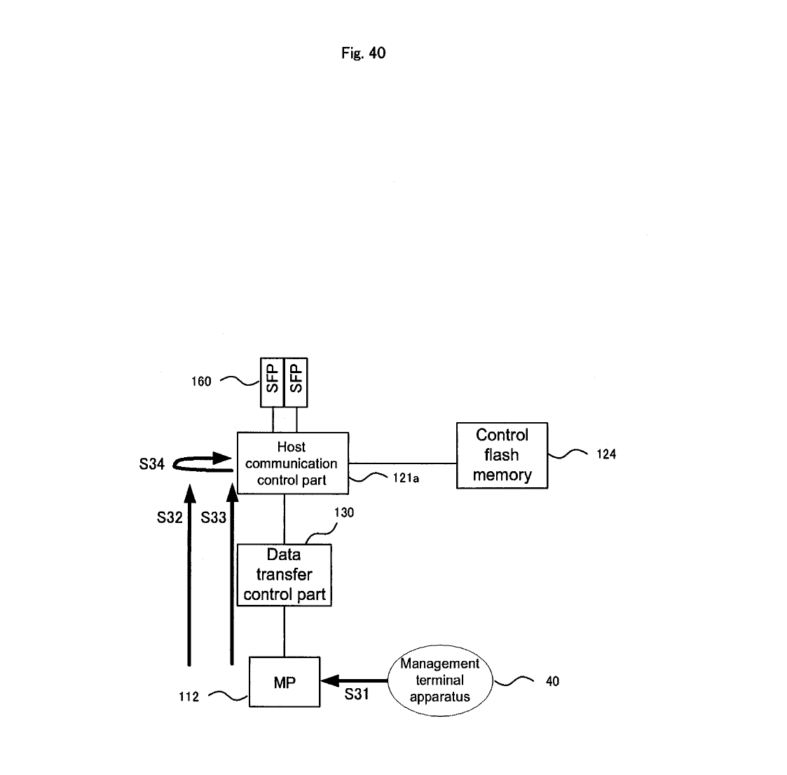

FIG. 40 schematically shows a variation of the protocol switching process. The management terminal apparatus 40, based on an operation by the user, sends the MP 112 an instruction to switch the protocol (S31). Thereafter, the MP 112 performs a hard reset with respect to the host communication control part 121a (S32). Thereafter, the MP 112 directly uploads to the host communication control part 121a program, such as firmware or the like, and parameter setting information comprising the identifier of the post-switch protocol (S33). The MP 112 also checks whether or not uploading is possible when the circuit board information is read. Thereafter, the host communication control part 121a reads the setting information from the uploaded program and parameter, and boots up based on the setting information (S34). In accordance with this, the host communication control part 121a operates using the post-switch protocol.

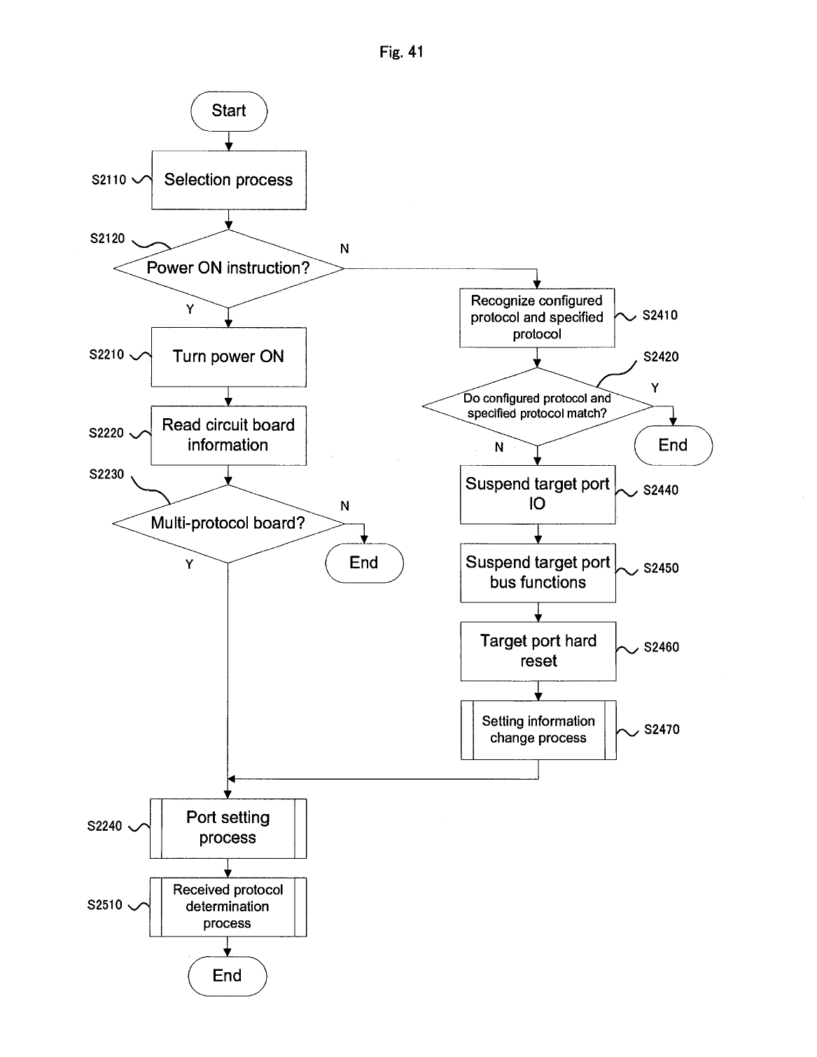

FIG. 41 shows the variation of the protocol switching process. Compared to the protocol switching process of FIG. 13, in this variation, the MP 112 performs S2440 and S2450 without performing S2430, and thereafter, performs a setting information change process (S2470) and moves the processing to S2240. S2460 corresponds to the above-described S32. S2470 corresponds to the above-described S33.

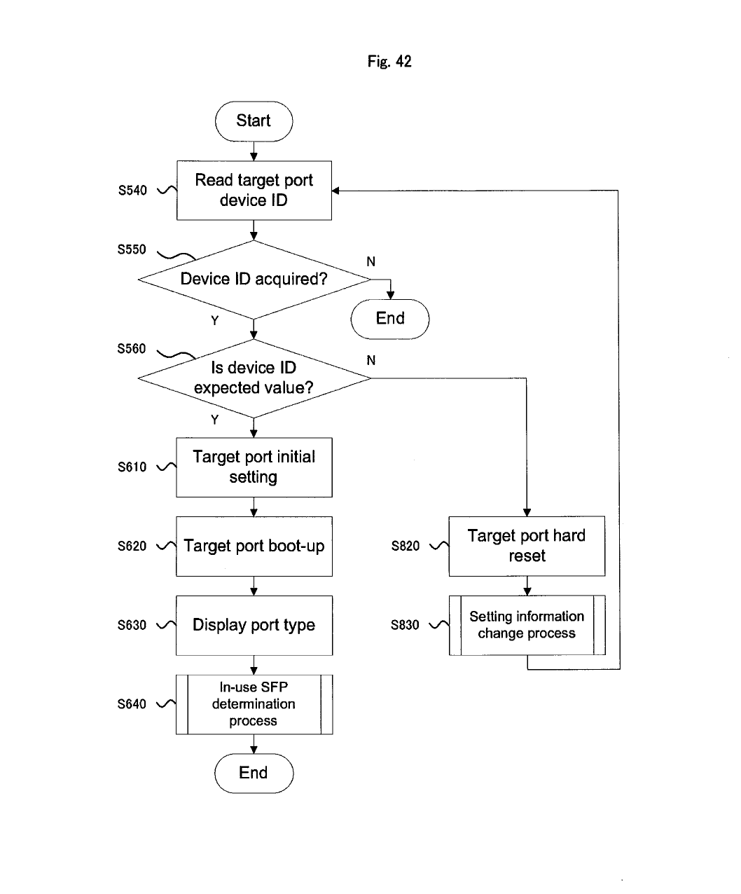

FIG. 42 shows a variation of the port setting process. Compared to the port setting process of FIG. 14, in this variation, the MP 112 performs S820 without performing S810, and thereafter performs the setting information change process (S830) and moves the processing to S540. S820 corresponds to the above-described S32. S830 corresponds to the above-described S33.

According to the above variation of the protocol switching process, the MP 112 is able to switch the protocol of the host communication control part 121a in accordance with uploading a program and a parameter to the host communication control part 121a.

### —Variation of Selection Process—

A variation of the selection process will be explained hereinbelow.

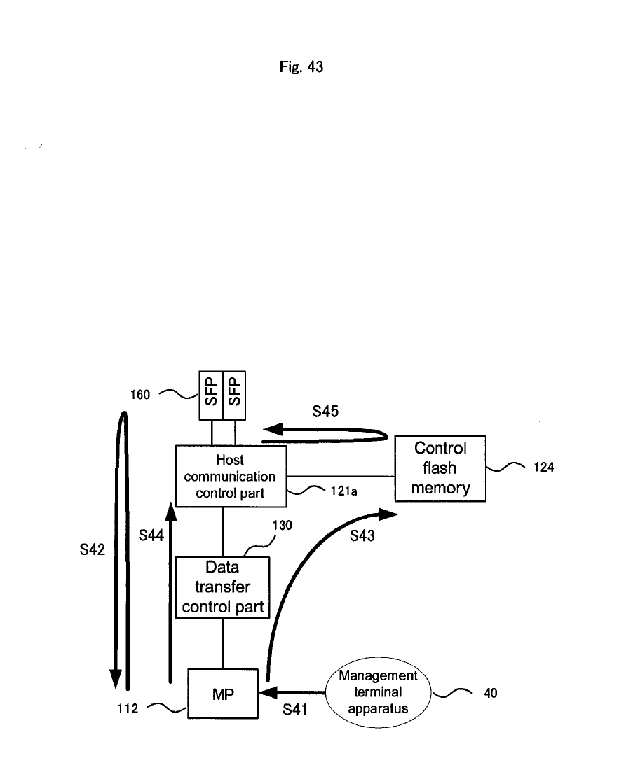

FIG. 43 schematically shows a variation of the selection process. The management terminal apparatus 40, based on an operation by the user, sends the MP 112 an instruction to switch the protocol (S41). Thereafter, the MP 112 reads the SFP type from the SFP 160, and decides the post-switch protocol based on the SFP type, which has been read, and the SFP type table 1120 (S42). Thereafter, the MP 112 writes setting information comprising the identifier of the post-switch protocol to the control flash memory 124 (S43). Thereafter, the MP 112 performs a hard reset with respect to the host communication control part 121a (S44). Thereafter, the host communication control part 121a reads the setting information from the control flash memory 124, and boots up based on the setting information (S45). In accordance with this, the host communication control part 121a operates using the post-switch protocol.

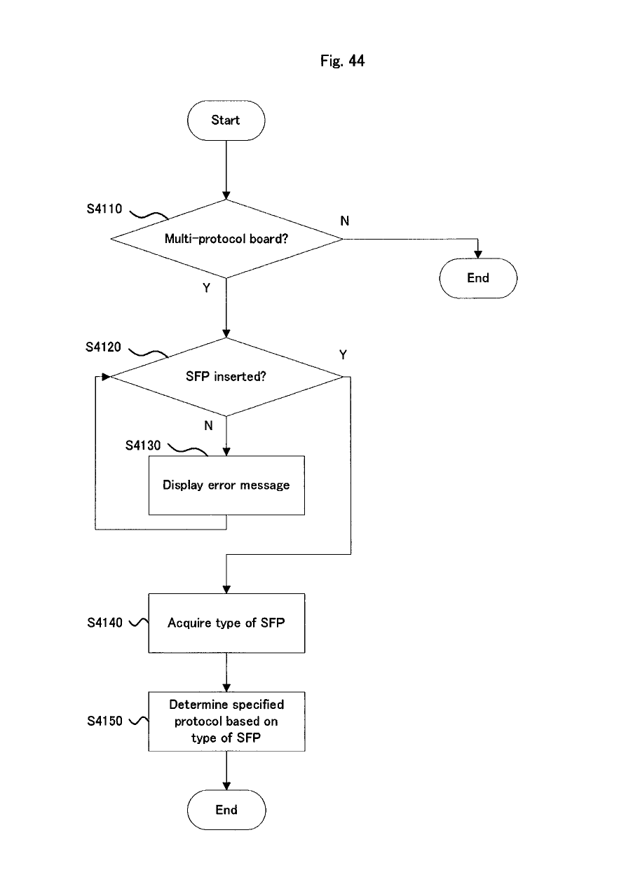

FIG. 44 shows the variation of the selection process. It is supposed here that the hardware pin of the channel coupling part 120 shows whether the channel coupling part 120 is a multi-protocol board or a single protocol board. The MP 112 checks the hardware pin and determines whether or not the hardware pin shows a multi-protocol board (S4110). In a case where it has been determined that the hardware pin shows a single protocol board (S4110: N), the MP 112 ends this flow. In a case where it has been determined that the hardware pin shows a multi-protocol board (S4110: Y), the MP 112 determines whether or not an SFP 160 is inserted in the SFP slot 123 of the target port (S4120). In a case where it has been determined that an SFP 160 is not inserted (S4120: N), the MP 112 displays an error message on the management terminal apparatus 40 via the management information control part 170, waits for a prescribed time (S4130), and moves the processing to S4120. The error message, for example, urges the user to insert an SFP as in “SFP not inserted. Please insert SFP.”

In a case where it has been determined that the SFP 160 is inserted (S4120: Y), the MP 112 acquires the SFP type from the SFP 160 via an I2C coupling or the like (S4140), decides the specified protocol based on the acquired SFP type and the SFP type table 1120 (S4150), and ends this flow. S4140 and S4150 correspond to the above-described S42.

According to the above variation of the selection process, the MP 112 is able to decide the specified protocol based on the inserted SFP 160 without requiring that the user specify a protocol.

The technology explained using the above examples can be expressed as follows.

### (Wording 1)

A storage apparatus, comprising:
a network interface part, which is coupled to a computer via a network; and
a controller, which is coupled to the network interface part, receives a request from the computer via the network and the network interface part, and accesses a storage medium based on the request,
wherein the controller specifies one protocol from among multiple protocols, and sends protocol information denoting the specified protocol to the network interface part, and
the network interface part configures a protocol denoted by the protocol information, and carries out communications with the network in accordance with the configured protocol.

### (Wording 2)

A storage apparatus according to wording 1, wherein
the network interface part comprises:
a communication control part for controlling communications between the network and the controller; and
a nonvolatile memory, which is coupled to the communication control part, and wherein
the controller writes the protocol information to the nonvolatile memory, and
the communication control part, upon being booted up, reads the protocol information from the nonvolatile memory, configures a protocol denoted by the protocol information, and carries out communications with the network in accordance with the configured protocol.

### (Wording 3)

A storage apparatus according to wording 2, wherein the controller, subsequent to the write, boots up the communication control part by performing a hardware reset for the communication control part.

### (Wording 4)

A storage apparatus according to wording 2, wherein the controller determines whether or not the configured protocol matches the specified protocol, and in a case where it has been determined that the configured protocol does not match the specified protocol, writes the protocol information to the nonvolatile memory.

### (Wording 5)

A storage apparatus according to wording 2, wherein the communication control part is coupled to the controller via a bus, and stores a device identifier for identifying the communication control part with respect to the bus, and
the controller stores an association between a device identifier and a protocol beforehand, acquires the device identifier from the communication control part via the bus, and recognizes the configured protocol based on the device identifier and the association.

### (Wording 6)

A storage apparatus according to wording 2, wherein, in a case where, as a result of the controller switching the communication control part protocol, a post-switch physical address type differs from a pre-switch physical address type with respect to the communication control part, the controller creates the post-switch physical address based on the pre-switch physical address, and writes the post-switch physical address to the nonvolatile memory.

### (Wording 7)

A storage apparatus according to wording 2, wherein the controller is coupled to an input/output apparatus, and displays on the input/output apparatus information denoting the specified protocol, which is obtained by, by means of the controller, acquiring a protocol decided in accordance with an input to the input/output apparatus and specifying the decided protocol as the specified protocol.

### (Wording 8)

A storage apparatus according to wording 7, wherein the controller displays on the input/output apparatus usable protocols of the multiple protocols in distinction from unusable protocols, and specifies a protocol selected from among the usable protocols in accordance with an input to the input/output apparatus as the specified protocol.

### (Wording 9)

A storage apparatus according to wording 7, wherein the communication control part is coupled to the network via a transceiver, and
the controller acquires information on the transceiver from the communication control part, determines whether or not the transceiver is compatible with the configured protocol based on the transceiver information, and in a case where the transceiver is not compatible with the configured protocol, displays on the input/output apparatus the fact that the transceiver is not compatible with the configured protocol.

### (Wording 10)

A storage apparatus according to wording 7, wherein the controller acquires from the communication control part reception information from the network, determines whether or not the reception is normal based on the reception information, and in a case where the reception is not normal, displays on the input/output apparatus the fact that the communications are not normal.

### (Wording 11)

A storage apparatus according to wording 2, further comprising:
a transfer part for transferring data between the communication control part and the controller,
wherein the controller comprises multiple microprocessor cores, and
upon receiving an IO request from the computer, the transfer part selects, as a transfer-destination core, a microprocessor core for processing the IO request from among the multiple microprocessor cores on the basis of a protocol of the IO request, and transfers the IO request to the transfer-destination core.

### (Wording 12)

A storage apparatus according to wording 2, wherein
the communication control part is coupled to the network via a transceiver, and
the controller acquires the transceiver information from the communication control part, and, based on the transceiver information, specifies a protocol corresponding to the transceiver from among the multiple protocols.

### (Wording 13)

A storage apparatus according to wording 1, wherein
the network interface part comprises a communication control part for controlling communications between the network and the controller,
the controller sends a program comprising the protocol information to the communication control part, and
the communication control part receives the sent program, configures the protocol denoted by the protocol information, and carries out communications with the network in accordance with the configured protocol.

### (Wording 14)

A network interface apparatus, comprising:
a connector, which is coupled to a controller of a storage apparatus;
a communication control part, which is coupled to the controller via the connector, and is coupled to a computer via a network, wherein
the communication control part acquires from the controller protocol information denoting one protocol specified by the controller from among multiple protocols, configures the protocol denoted by the protocol information, and carries out communications with the network in accordance with the configured protocol.

### (Wording 15)

A storage control method for controlling a storage apparatus, which comprises a network interface part coupled to a computer via a network, and a controller coupled to the network interface part,
the storage control method comprising:
specifying by the controller one protocol from among multiple protocols;
sending by the controller protocol information denoting the specified protocol to the network interface part;
configuring by the network interface part a protocol denoted by the protocol information; and
carrying out by the network interface part communications with the network in accordance with the configured protocol.

The terminology in these wordings will be explained. The computer, for example, corresponds to the host computer 20. The nonvolatile memory, for example, corresponds to the control flash memory 124. The communication control part, for example, corresponds to the host communication control parts 121a and 121c. The storage medium, for example, corresponds to the drive 150. The protocol information, for example, corresponds to the protocol ID. The device identifier, for example, corresponds to the device ID. The input/output apparatus, for example, corresponds to the management terminal apparatus 40. The transceiver, for example, corresponds to the host coupling part 160h and the SFP 160. The display part, for example, corresponds to the protocol display part 128. The transfer part, for example, corresponds to the channel control part 126a. The network interface part or the network interface apparatus, for example, corresponds to the channel coupling part 120a, 120c.

### REFERENCE SIGNS LIST

10, 10P Storage apparatus
20 Host computer
30 Externally coupled storage apparatus
40 Management terminal apparatus
50 Network
60 Network
100, 100P Controller
110 Information processing part
111 Processor coupling part
113 Local memory
114 Internal bus I/F
120, 120a, 120b, 120c, 120d, 120p Channel coupling part
121a, 121b Host communication control part
122 Internal bus I/F
123, 123a, 123b SFP slot
124 Control flash memory
125 Bus flash memory
126a, 126b Channel control part
127a, 127b Channel control memory
128 Protocol display part
130, 130p Data transfer control part
140, 140p Disk coupling part
150 Drive
160h Host coupling part
170 Management information control part
180 Cache memory
190h Interface coupling part

1. A storage apparatus, comprising:
a network interface part, which is coupled to a computer via a network; and
a controller, which is coupled to the network interface part, receives a request from the computer via the network and the network interface part, and accesses a storage medium based on the request,
wherein the controller specifies one protocol from among multiple protocols, and sends protocol information denoting the specified protocol to the network interface part, and
the network interface part configures a protocol denoted by the protocol information, and carries out communications with the network in accordance with the configured protocol.

2. A storage apparatus according to claim 1, wherein
the network interface part comprises:
a communication control part for controlling communications between the network and the controller; and
a nonvolatile memory, which is coupled to the communication control part, and wherein
the controller writes the protocol information to the nonvolatile memory, and
the communication control part, upon being booted up, reads the protocol information from the nonvolatile memory, configures a protocol denoted by the protocol information, and carries out communications with the network in accordance with the configured protocol.

3. A storage apparatus according to claim 2, wherein the controller, subsequent to the write, boots up the communication control part by performing a hardware reset for the communication control part.

4. A storage apparatus according to claim 2, wherein the controller determines whether or not the configured protocol matches the specified protocol, and in a case where it has been determined that the configured protocol does not match the specified protocol, writes the protocol information to the nonvolatile memory.

5. A storage apparatus according to claim 2, wherein the communication control part is coupled to the controller via a bus, and stores a device identifier for identifying the communication control part with respect to the bus, and
the controller stores an association between a device identifier and a protocol beforehand, acquires the device identifier from the communication control part via the bus, and recognizes the configured protocol based on the device identifier and the association.

6. A storage apparatus according to claim 2, wherein, in a case where, as a result of the controller switching the communication control part protocol, a post-switch physical address type differs from a pre-switch physical address type with respect to the communication control part, the controller creates the post-switch physical address based on the pre-switch physical address, and writes the post-switch physical address to the nonvolatile memory.

7. A storage apparatus according to claim 2, wherein the controller is coupled to an input/output apparatus, and displays on the input/output apparatus information denoting the specified protocol, which is obtained by, by means of the controller, acquiring a protocol decided in accordance with an input to the input/output apparatus and specifying the decided protocol as the specified protocol.

8. A storage apparatus according to claim 7, wherein the controller displays on the input/output apparatus usable protocols of the multiple protocols in distinction from unusable protocols, and specifies a protocol selected from among the usable protocols in accordance with an input to the input/output apparatus as the specified protocol.

9. A storage apparatus according to claim 7, wherein the communication control part is coupled to the network via a transceiver, and
the controller acquires information on the transceiver from the communication control part, determines whether or not the transceiver is compatible with the configured protocol based on the transceiver information, and in a case where the transceiver is not compatible with the configured protocol, displays on the input/output apparatus the fact that the transceiver is not compatible with the configured protocol.

10. A storage apparatus according to claim 7, wherein the controller acquires from the communication control part reception information from the network, determines whether or not the reception is normal based on the reception information, and in a case where the reception is not normal, displays on the input/output apparatus the fact that the communications are not normal.

11. A storage apparatus according to claim 2, further comprising:
a transfer part for transferring data between the communication control part and the controller,
wherein the controller comprises multiple microprocessor cores, and
upon receiving an IO request from the computer, the transfer part selects, as a transfer-destination core, a microprocessor core for processing the IO request from among the multiple microprocessor cores on the basis of a protocol of the IO request, and transfers the IO request to the transfer-destination core.

12. A storage apparatus according to claim 2, wherein
the communication control part is coupled to the network via a transceiver, and
the controller acquires the transceiver information from the communication control part, and, based on the transceiver information, specifies a protocol corresponding to the transceiver from among the multiple protocols.

13. A storage apparatus according to claim 1, wherein
the network interface part comprises a communication control part for controlling communications between the network and the controller,
the controller sends a program comprising the protocol information to the communication control part, and
the communication control part receives the sent program, configures the protocol denoted by the protocol information, and carries out communications with the network in accordance with the configured protocol.

14. A network interface apparatus, comprising:
a connector, which is coupled to a controller of a storage apparatus;
a communication control part, which is coupled to the controller via the connector, and is coupled to a computer via a network, wherein
the communication control part acquires from the controller protocol information denoting one protocol specified by the controller from among multiple protocols, configures the protocol denoted by the protocol information, and carries out communications with the network in accordance with the configured protocol.

15. A storage control method for controlling a storage apparatus, which comprises a network interface part coupled to a computer via a network, and a controller coupled to the network interface part,
the storage control method comprising:
specifying by the controller one protocol from among multiple protocols;
sending by the controller protocol information denoting the specified protocol to the network interface part;
configuring by the network interface part a protocol denoted by the protocol information; and
carrying out by the network interface part communications with the network in accordance with the configured protocol.
